(19) United States
(12) Patent Application Publication
(10) Pub. No.: US 2026/0332910 A1
(43) Pub. Date: Oct. 22, 2026

(54) IMAGING ELEMENT AND ELECTRONIC APPARATUS

(71) Applicant: SONY SEMICONDUCTOR SOLUTIONS CORPORATION, KANAGAWA (JP)

(72) Inventor: SHUNSUKE SAKAMA, KANAGAWA (JP)

(21) Appl. No.: 19/122,098

(22) PCT Filed: Aug. 31, 2023
(86) PCT No.: PCT/JP2023/031946

§ 371 Date: Apr. 17, 2025

(30) Foreign Application Priority Data
Oct. 25, 2022 (JP) 2022-170452

(51) Int. Cl. H04N 25/773; H04N 25/532; H04N 25/771

(52) U.S. Cl. CPC H04N 25/773; H04N 25/532; H04N 25/771

(57) ABSTRACT

To derive (estimate) a correct number of incident photons even in a case where a temporal change occurs in incident illuminance during an exposure period.

An imaging element according to the present technology includes a light receiving element that is provided for each pixel and detects the presence or absence of photons, and a detection circuit that is provided corresponding to the light receiving element and detects photons incident on the light receiving element. In this imaging element, the detection circuit includes a photon detection unit that detects photons incident on the light receiving element by recharge control with a plurality of periods with respect to the light receiving element, a plurality of storage units, and a selection control unit that selects one of the plurality of storage units as a storage unit that stores the number of detected photons detected by the photon detection unit.

### TECHNICAL FIELD

The present technology relates to an imaging element. Specifically, the present technology relates to an imaging element that includes a light receiving element configured to detect the presence or absence of photons for each pixel, and an electronic apparatus including the imaging element.

### BACKGROUND ART

As an imaging element mounted in an electronic apparatus such as an imaging device, an imaging element including a light receiving element that detects the presence or absence of photons for each pixel and performing photon detection by recharge control with a plurality of periods on this light receiving element is known. For example, there is known a technology of combining a plurality of periods of a recharge pulse (reset pulse) to control recharge of a light receiving element so as not to lose a monotonically increase in count values of the number of detected photons even in a case where photons are incident with high frequency while maintaining detection capability at the time of incident photons with low frequency (see, for example, Patent Document 1).

### CITATION LIST

### Patent Document

Patent Document 1: Japanese Patent Application Laid-Open No. 07-067043

### SUMMARY OF THE INVENTION

### Problems to be Solved by the Invention

In the related art described above, the non-linearity of the input/output characteristics is enhanced, and the dynamic range is expanded by combining a plurality of types of recharge pulse periods (that is, recharge control periods) to perform recharge control. However, since a period for reading the number of detected photons after the end of the exposure period is required, there is a problem that the proportion of a light-receiving period decreases during high-frame-rate imaging.

The present technology has been made in view of such a circumstance, and an object thereof is to improve a frame rate without impairing a light-receiving period in recharge control with a plurality of periods.

### Solutions to Problems

The present technology has been made to solve the above-described problem, and a first aspect thereof is an imaging element including: a light receiving element configured to detect a presence or absence of a photon, the light receiving element being provided for each pixel; and a detection circuit configured to detect a photon incident on the light receiving element, the detection circuit being provided corresponding to the light receiving element, in which the detection circuit includes a photon detection unit configured to detect a photon incident on the light receiving element by recharge control with a plurality of periods with respect to the light receiving element, a plurality of storage units, and a selection control unit configured to select one of the plurality of storage units as a storage unit configured to store a number of detected photons detected by the photon detection unit. Therefore, this brings about an effect that in the recharge control with the plurality of periods, the frame rate by the number of storage units is substantially improved.

Furthermore, in the first aspect, the detection circuit may further include a counter configured to count a pulse generated when the photon detection unit detects a photon, the plurality of storage units may be constructed by utilizing memories, each storing a count value of the counter, and the selection control unit may be disposed between the counter and the plurality of storage units, and may perform a control to selectively input the count value of the counter to the plurality of storage units. Therefore, this brings about an effect that in the recharge control with the plurality of periods, the frame rate by the number of storage units is substantially improved.

Furthermore, in the first aspect, the detection circuit may further include a read control unit configured to read, during a hold period of one storage unit of the plurality of storage units, a hold value of another storage unit. Therefore, this brings about an effect that the pipeline operation is achieved, and it is possible to minimize the interruption of the exposure during a read period in a global shutter operation of simultaneously scanning all regions of an image.

Furthermore, in the first aspect, the plurality of storage units may be constructed by utilizing counters, each counting a pulse generated when the photon detection unit detects a photon, and the selection control unit may be disposed between the photon detection unit and the plurality of storage units, and performs a control to selectively input the number of detected photons to the plurality of storage units. Therefore, this brings about an effect that the number of detected photons can be directly counted by the plurality of storage units.

Furthermore, in the first aspect, each counter of the plurality of storage units may repeat a period in which a counting operation is performed and a period in which a counting operation is not performed a plurality of times. Therefore, this brings about an effect that since the light-receiving periods in the respective counters constituting the plurality of storage units can be dispersed, it is possible to obtain simultaneously an imaging result to which an electronic neutral density (ND) filter is applied and an imaging result obtained by normal exposure.

Furthermore, in the first aspect, the selection control unit may perform an operation of selecting one of the plurality of storage units in synchronization with switching of a period of the recharge control. Therefore, this brings about an effect that since the count values of the number of detected photons from a plurality of different input/output characteristics can be obtained by one exposure, it is possible to derive (estimate) the correct number of incident photons even in a case where the incident illuminance changes over time during the exposure period.

Furthermore, in the first aspect, the selection control unit may generate a selection pulse for selecting one of the plurality of storage units, and the photon detection unit may perform the recharge control with the plurality of periods in synchronization with the selection pulse. Therefore, this brings about an effect that the gamma curve (input/output characteristics) can be adjusted after reading the count values without losing the original SN ratio.

Furthermore, in the first aspect, the detection circuit may further include a recharge period switching control unit configured to switch the period of the recharge control, and the selection control unit may generate a selection pulse for selecting one of the plurality of storage units in synchronization with a switching signal output from the recharge period switching control unit. Therefore, this brings about an effect that since the illuminance change during the exposure can be estimated from the count value of the number of detected photons in the plurality of input/output characteristics, it is possible to respond to the change in the illuminance of faster-moving objects.

Furthermore, in the first aspect, the detection circuit may further include a recharge period switching control unit configured to switch the period of the recharge control, and the photon detection unit may generate a selection pulse for selecting one of the plurality of storage units on the basis of a switching signal output from the recharge period switching control unit. Therefore, this brings about an effect that since the number of detected photons can be counted with a combination of the long and short recharge periods, the dynamic range of the input/output characteristics in each counter can be expanded.

Furthermore, in the first aspect, the imaging element may have a stacked structure in which at least two semiconductor substrates are stacked, the at least two semiconductor substrates including a first semiconductor substrate on which the light receiving element is formed and a second semiconductor substrate on which the detection circuit is formed. Therefore, this brings about an effect that in manufacturing the imaging element with the stacked structure, the process optimization can be achieved for each semiconductor substrate.

Furthermore, in the first aspect, the imaging element may further include a selection pulse generation unit configured to generate a selection pulse for selecting one of the plurality of storage units, in which the selection pulse generation unit may be disposed on the second semiconductor substrate outside a pixel array unit in which the detection circuits are disposed in an array. Therefore, this brings about an effect that the circuit area of the region of the detection circuit disposed per pixel on the second semiconductor substrate can be reduced to be smaller than the case where the selection pulse generation unit is disposed in the pixel.

Furthermore, in the first aspect, the imaging element may further include a selection pulse generation unit configured to generate a selection pulse for selecting one of the plurality of storage units, and the selection pulse generation unit may be disposed on the second semiconductor substrate inside a pixel array unit in which the detection circuits are disposed in an array, and the selection pulse generation unit is disposed to form a pair with each detection circuit. Therefore, this brings about an effect that the circuit area of the region forming the circuit outside the pixel array unit on the second semiconductor substrate can be reduced to be smaller than the case where the selection pulse generation unit is disposed outside the pixel array unit.

Furthermore, in the first aspect, the imaging element may further include an arithmetic processing unit configured to obtain an image output on the basis of each output value of the plurality of storage units. Therefore, this brings about an effect that one image output can be calculated or a plurality of image outputs can be calculated on the basis of each output value of the plurality of storage units.

Furthermore, in the first aspect, the arithmetic processing unit may obtain incident illuminance in a plurality of exposure periods from each output value of the plurality of storage units, and obtain average illuminance of the incident illuminance in the plurality of exposure periods. Therefore, this brings about an effect that by obtaining the average illuminance in consideration of the illuminance change during the exposure period, it is possible to respond to the change in the illuminance of faster-moving objects.

Furthermore, in the first aspect, the light receiving element may be avalanche diodes, for example, a single photon avalanche diode. Therefore, this brings about an effect that a signal can be generated in response to reception of photons.

Furthermore, in a second aspect of the present technology, an electronic apparatus includes an imaging element, in which the imaging element includes: a light receiving element configured to detect a presence or absence of a photon, the light receiving element being provided for each pixel; and a detection circuit configured to detect a photon incident on the light receiving element, the detection circuit being provided corresponding to the light receiving element, the detection circuit including a photon detection unit configured to detect a photon incident on the light receiving element by recharge control with a plurality of periods with respect to the light receiving element, a plurality of storage units, and a selection control unit configured to select one of the plurality of storage units as a storage unit configured to store a number of detected photons detected by the photon detection unit. Therefore, this brings about an effect that in the recharge control with the plurality of periods, the frame rate by the number of storage units is substantially improved in the imaging element of the electronic apparatus.

### BRIEF DESCRIPTION OF DRAWINGS

FIG. 1 is a perspective view schematically illustrating a semiconductor chip structure of an imaging element according to a first embodiment of the present technology.

FIG. 2 is a block diagram illustrating an example of a circuit configuration of a pixel of the imaging element according to the first embodiment of the present technology.

FIG. 3 is a timing chart for explaining an example of a circuit operation of the pixel of the imaging element according to the first embodiment of the present technology.

FIG. 4 is a block diagram illustrating an example of a circuit configuration of a pixel of an imaging element according to a second embodiment of the present technology.

FIG. 5 is a timing chart for explaining an example of a circuit operation of the pixel of the imaging element according to the second embodiment of the present technology.

FIG. 6 is a block diagram illustrating an example of a circuit configuration of a pixel of an imaging element according to a third embodiment of the present technology.

FIG. 7 is a timing chart for explaining an example of a circuit operation of the pixel of the imaging element according to the second embodiment of the present technology.

FIG. 8 is a block diagram illustrating an example of a circuit configuration of a pixel of an imaging element according to a fourth embodiment of the present technology.

FIG. 9 is a timing chart for explaining an example of a circuit operation of the pixel of the imaging element according to the fourth embodiment of the present technology.

FIG. 10 is a diagram for explaining a method of estimating incident illuminance from count values of different input/output characteristics in the fourth embodiment of the present technology.

FIG. 11 is a diagram for explaining a method of acquiring the count values from a plurality of input/output characteristics in the fourth embodiment of the present technology.

FIG. 12 is a diagram illustrating input/output characteristics A and B obtained for each storage unit in the fourth embodiment of the present technology.

FIG. 13 is a diagram for explaining the technology according to a reference example.

FIG. 14 is a diagram for explaining a case where the input/output characteristics are nonlinear and a case where the input/output characteristics are linear.

FIG. 15 is a block diagram illustrating an example of a circuit configuration of a pixel of an imaging element according to a fifth embodiment of the present technology.

FIG. 16 is a timing chart for explaining an example of a circuit operation of the pixel of the imaging element according to the fifth embodiment of the present technology.

FIG. 17 is a block diagram illustrating an example of a circuit configuration of a pixel of an imaging element according to a sixth embodiment of the present technology.

FIG. 18 is a timing chart for explaining an example of a circuit operation of the pixel of the imaging element according to the sixth embodiment of the present technology.

FIG. 19 is a block diagram illustrating an example of a circuit configuration of a pixel of an imaging element according to a seventh embodiment of the present technology.

FIG. 20 is a timing chart for explaining an example of a circuit operation of the pixel of the imaging element according to the seventh embodiment of the present technology.

FIG. 21 is a block diagram illustrating a configuration example of an imaging element according to an eighth embodiment of the present technology.

FIG. 22 is a block diagram illustrating a configuration example of an imaging element according to a ninth embodiment of the present technology.

FIG. 23 is a block diagram illustrating a circuit configuration example of an arithmetic processing unit according to a tenth embodiment of the present technology.

FIG. 24 is a diagram for explaining an arithmetic processing unit according to an eleventh embodiment of the present technology.

FIG. 25 is a flowchart illustrating a specific processing flow of the arithmetic processing unit according to the eleventh embodiment of the present technology.

FIG. 26 is a diagram for explaining an arithmetic processing unit according to a twelfth embodiment of the present technology.

FIG. 27 is a block diagram illustrating a configuration example of an imaging device which is an example of an electronic apparatus to which the present technology is applied.

FIG. 28 is a diagram illustrating an example of fields to which the embodiments of the present technology are applied.

FIG. 29 is a block diagram illustrating a schematic configuration example of a vehicle control system.

FIG. 30 is an explanatory diagram illustrating an example of an installation position of an imaging section.

### MODE FOR CARRYING OUT THE INVENTION

Modes for carrying out the present technology (hereinafter, referred to as embodiments) will be described below. The description will be given in the following order.
1. First Embodiment (Example of Counting The Number of Detected Photons by Using Counter, Providing Plurality of Storage Units Storing Count Values, and Using Memory as Storage Units)
2. Second Embodiment (Modification of First Embodiment: Example of Implementing Pipeline Operation)
3. Third Embodiment (Example of Configuration of Plurality of Storage Units With Counter, and Counting The Number of Detected Photons by Plurality of Storage Units)
4. Fourth Embodiment (Example of Synchronizing Switching of Period of Recharge Control and Operation of Selecting One of Plurality of Storage Units in Configuration of First Embodiment)
5. Fifth Embodiment (Example of Synchronizing Switching of Period of Recharge Control and Operation of Selecting One of Plurality of Storage Units in Configuration of Third Embodiment)
6. Sixth Embodiment (Example of Switching Between Plurality of Storage Units On The Basis Of Signal for Switching of Period of Recharge Control)
7. Seventh Embodiment (Example of Generating Selection Pulse for Switching Between Plurality of Storage Units in Recharge Control Unit Generating Reset Pulse)
8. Eighth Embodiment (Example of Generating Selection Pulse for Switching Between Plurality of Storage Units Outside Pixel Array Unit)
9. Ninth Embodiment (Example of Generating Selection Pulse for Switching Between Plurality of Storage Units in Each Pixel Inside Pixel Array Unit)
10. Tenth Embodiment (Example of Obtaining Image Output On The Basis Of Each Output Value of Plurality of Storage Units)
11. Eleventh Embodiment (Example of Obtaining Average Illuminance In Consideration Of Illuminance Change During Exposure Period and Estimating Incident Illuminance)
12. Twelfth Embodiment (Example of Obtaining Estimated Illuminance That Most Matches Combination of Output Values of Plurality of Storage Units Using Inverse Function Table Prepared In Advance)
13. Modifications
14. Application Example to Electronic Apparatus (Electronic Apparatus of Present Technology)
15. Application Example of Embodiments of Present Technology
16. Practical Example to Mobile Object>17. Configuration That Present Technology Can Employ

### First Embodiment

A first embodiment of the present technology is an example of counting the number of detected photons by using a counter, providing a plurality of storage units storing the count values, and using a memory as the storage units.

For an imaging element according to the first embodiment of the present technology, for example, a single photon avalanche diode (SPAD) element operating in a Geiger mode is used as a light receiving element that is provided for each pixel and detects the presence or absence of photons. That is, the light receiving element of the pixel is not limited to the SPAD element, and in addition to the SPAD element, various elements operating in the Geiger mode, such as an avalanche photodiode (APD), can be used. The same applies to the embodiments described later.

### [Semiconductor Chip Structure of Imaging Element]

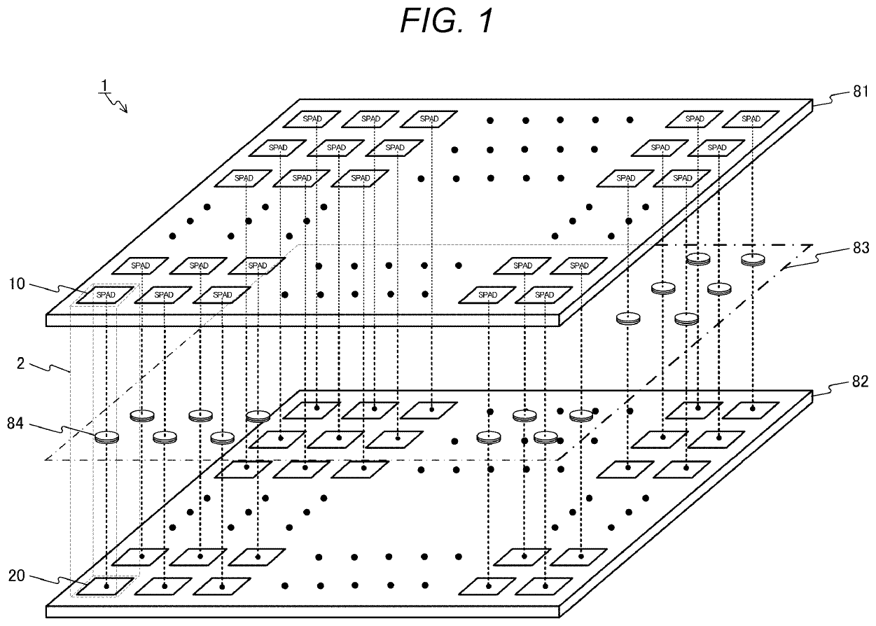

FIG. 1 is a perspective view schematically illustrating a semiconductor chip structure of an imaging element 1 according to the first embodiment of the present technology. Here, as the semiconductor chip structure of the imaging element 1 according to the first embodiment, a stacked semiconductor chip structure in which at least two semiconductor substrates (chips) of a first semiconductor substrate 81 and a second semiconductor substrate 82 are stacked is exemplified.

In this stacked semiconductor chip structure (so-called stacked structure), the first semiconductor substrate 81 is a sensor chip provided for each pixel 2, the first semiconductor substrate 81 being provided with SPAD elements 10 disposed in a two-dimensional array, as an example of light receiving elements that detect the presence or absence of photons. The second semiconductor substrate 82 is a logic chip in which detection circuits 20 that detect photons incident on the SPAD elements 10 and are disposed in a two-dimensional array, the detection circuits 20 corresponding to the SPAD elements 10 in the first semiconductor substrate 81, respectively.

The SPAD elements 10 on the first semiconductor substrate 81 and the detection circuits (logic circuits) 20 on the second semiconductor substrate 82 are electrically connected via connecting parts 84 formed in a wiring layer 83 interposed between the first semiconductor substrate 81 and the second semiconductor substrate 82. As an example of the connecting parts 84 of the wiring layer 83, Cu—Cu connection for directly connecting Cu electrodes can be exemplified.

According to the stacked semiconductor chip structure described above, a process suitable for manufacturing the SPAD elements 10 can be applied to the first semiconductor substrate 81, and a process suitable for manufacturing the detection circuits (logic circuits) 20 can be applied to the second semiconductor substrate 82. That is, in manufacturing the imaging element 1 with the stacked structure according to the first embodiment, the process optimization can be achieved for each semiconductor substrate.

Note that, here, although the stacked semiconductor chip structure has been exemplified as the semiconductor chip structure of the imaging element 1 according to the first embodiment, it is also possible to adopt a flat semiconductor chip structure in which the SPAD elements 10 and the detection circuits 20 are formed on the same semiconductor substrate.

### [Example of Circuit Configuration of Pixel]

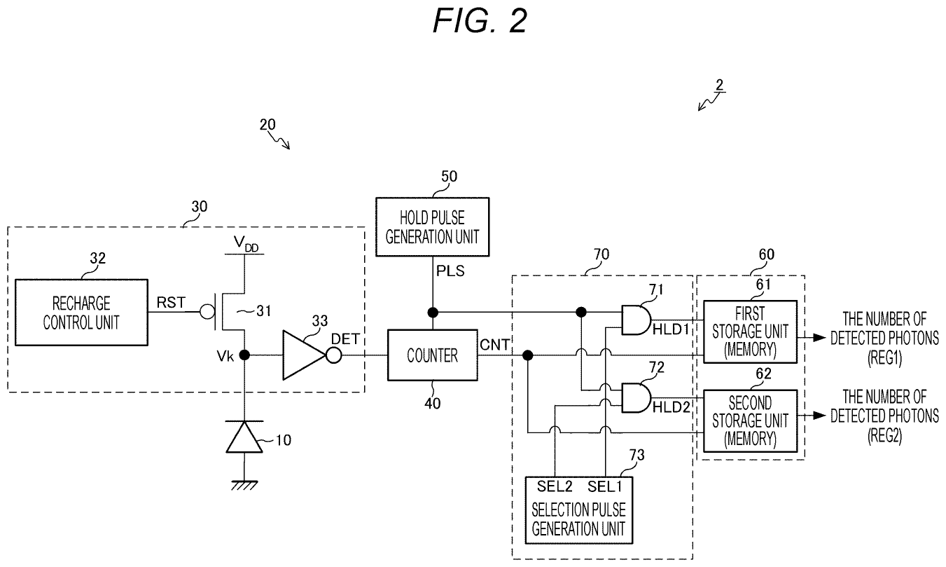

FIG. 2 is a block diagram illustrating an example of a circuit configuration of a pixel 2 of the imaging element 1 according to the first embodiment of the present technology. FIG. 2 illustrates the example of the circuit configuration for one pixel, and illustrates a case where two storage units that store the number of detected photons are provided. The same applies to the embodiments described later.

The pixel 2 of the imaging element 1 according to the first embodiment of the present technology includes a SPAD element 10 that detects the presence or absence of photons, and a detection circuit 20 that is provided corresponding to the SPAD element 10 and detects photons incident on the SPAD element 10.

For example, the SPAD element 10 has an anode grounded and operates at a reverse-bias voltage equal to or higher than the breakdown voltage, and in a case where light is incident, and even a single electron-hole pair is generated, the pair acts a seed to generate an avalanche current. As a result, even though one photon is incident, the SPAD element 10 can perform detection with a certain photon detection efficiency (PDE).

The detection circuit 20 includes a photon detection unit 30, a counter 40, a hold pulse generation unit 50, a storage unit 60, and a selection control unit 70.

In the detection circuit 20 having the above-described configuration, the photon detection unit 30 includes a recharge transistor 31, a recharge control unit 32, and a waveform shaping unit 33, and detects photons incident on the SPAD element 10 by performing recharge control with a plurality of periods on the SPAD element 10 to generate a detection pulse.

The recharge transistor 31 includes, for example, a P-type metal oxide semiconductor (MOS) transistor, is connected between the node of a power supply voltage V_{DD} and the cathode of the SPAD element 10, and performs recharge on the SPAD element 10.

The recharge control unit 32 has an output terminal connected to the gate of the recharge transistor 31, outputs a reset pulse RST with a plurality of different periods, and provides the reset pulse RST to the gate of the recharge transistor 31. That is, this reset pulse RST is a recharge pulse to control the recharge timing of the SPAD element 10.

The waveform shaping unit 33 includes, for example, a CMOS inverter, performs waveform shaping of a cathode voltage Vk that is an output of the SPAD element 10, and outputs the result as a detection pulse DET.

The counter 40 counts the detection pulse DET generated by the photon detection unit 30. A count value CNT of the counter 40 corresponds to the number of detected photons of the SPAD element 10.

The hold pulse generation unit 50 generates a hold pulse PLS to be provided to the counter 40, and controls the counter 40 by applying the hold pulse PLS.

The storage unit 60 includes a plurality of storage units, for example, formed with two storage units of a first storage unit 61 and a second storage unit 62. In the first embodiment, the first storage unit 61 and the second storage unit 62 are constructed by utilizing, for example, memories. The first storage unit 61 and the second storage unit 62 have a 2-input configuration, and the count value CNT of the counter 40 is used as one input.

The selection control unit 70 includes a 2-input first AND circuit 71, a 2-input second AND circuit 72, and a selection pulse generation unit 73.

The 2-input first AND circuit 71 uses a hold pulse PLS generated by the hold pulse generation unit 50 as one input and a selection pulse SEL1 generated by the selection pulse generation unit 73 as the other input, and generates a hold signal HLD1 on the basis of these two inputs. The hold signal HLD1 generated by the first AND circuit 71 is supplied to the first storage unit 61 as other input.

The 2-input second AND circuit 72 uses a hold pulse PLS generated by the hold pulse generation unit 50 as one input and a selection pulse SEL2 generated by the selection pulse generation unit 73 as the other input, and generates a hold signal HLD2 on the basis of these two inputs. The hold signal HLD2 generated by the second AND circuit 72 is supplied to the second storage unit 62 as other input.

The selection pulse generation unit 73 generates selection pulses SEL1 and SEL2 for selecting one of the plurality of storage units of the storage unit 60, as a storage unit that stores the count value CNT of the counter 40 corresponding to the number of detected photons, in the present example, the first storage unit 61 or the second storage unit 62, and provides the selection pulses SEL1 and SEL2 to the first AND circuit 71 and the second AND circuit 72 as the other inputs.

The first storage unit 61 stores a count value CNT output from the counter 40 under the control of the hold signal HLD1 applied from the first AND circuit 71. A hold value REG1 of the first storage unit 61 corresponds to the number of detected photons detected by the photon detection unit 30, and is output as a pixel signal corresponding to photons incident on the SPAD element 10 during a predetermined exposure period.

The second storage unit 62 stores a count value CNT output from the counter 40 under the control of the hold signal HLD2 applied from the second AND circuit 72. A hold value REG2 of the second storage unit 62 corresponds to the number of detected photons detected by the photon detection unit 30, and is output as a pixel signal corresponding to photons incident on the SPAD element 10 during a predetermined exposure period.

### [Example of Circuit Operation of Pixel]

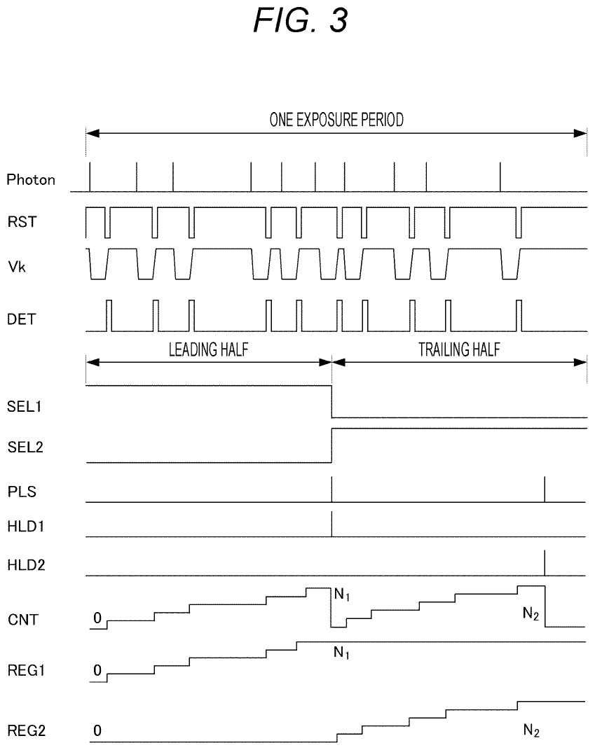

An example of a circuit operation of the pixel 2 according to the first embodiment of the above-described configuration will be described. FIG. 3 is a timing chart for explaining an example of a circuit operation of the pixel 2 of the imaging element 1 according to the first embodiment. Here, the timing relationship in one exposure period is illustrated.

FIG. 3 illustrates a timing relationship among the reset pulse RST, the cathode voltage Vk of the SPAD element 10, the detection pulse DET, the selection pulses SEL1 and SEL2, the hold pulse PLS, the hold signals HLD1 and HLD2, the count value CNT, and the hold values REG1 and REG2 with respect to incident photons.

As illustrated in the timing chart of FIG. 3, the selection pulse SEL1 is the high level and the selection pulse SEL2 is the low level in the leading half of one exposure period, and the selection pulse SEL1 is the low level and the selection pulse SEL2 is the high level in the trailing half of one exposure period. As a result, in the imaging element 1 according to the first embodiment, a circuit operation, in which the first storage unit 61 stores a count value N1 of the counter 40 in the leading half of the one exposure period, and the second storage unit 62 stores a count value N2 of the counter 40 in the trailing half of the one exposure period, is performed. With this circuit operation, the first storage unit 61 and the second storage unit 62 store the count values N1 and N2 for different time slots in one exposure period, respectively.

As described above, in the imaging element 1 according to the first embodiment, an operation is performed to store, in the different storage units, the count values N1 and N2 of the counter 40 in the different time slots in one exposure period, and to output the number of storage units as an imaging result under recharge control of the SPAD element 10 with a plurality of periods. As a result, in the recharge control with the plurality of periods, it is possible to substantially improve the frame rate by the number of storage units.

### Second Embodiment

A second embodiment of the present technology is a modification of the first embodiment of counting the number of detected photons by using the counter, providing the plurality of storage units storing the count values, and using the memory as the storage units, and an example of implementing a pipeline operation.

### [Example of Circuit Configuration of Pixel]

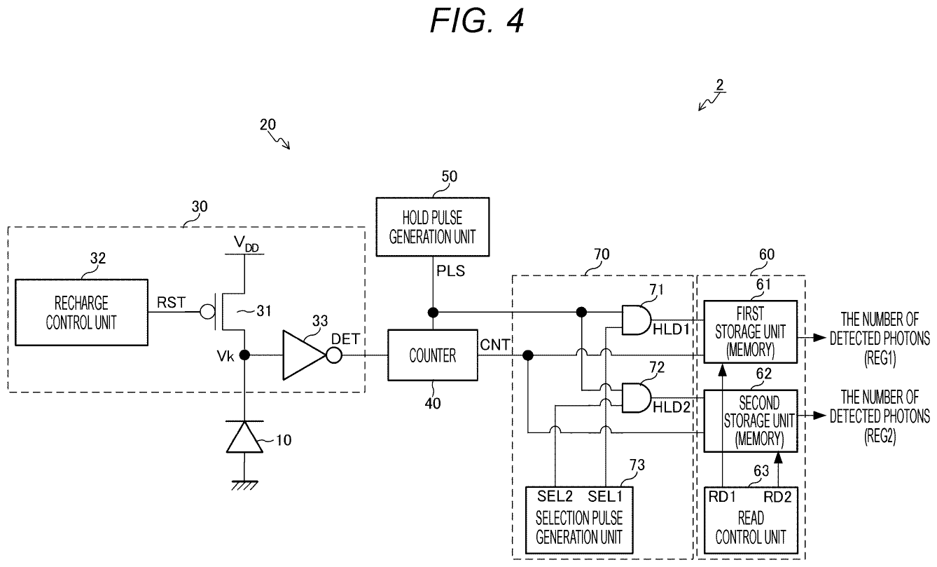

FIG. 4 is a block diagram illustrating an example of a circuit configuration of a pixel 2 of an imaging element 1 according to a second embodiment of the present technology.

Similar to the case of the first embodiment, the pixel 2 of the imaging element 1 according to the second embodiment has the configuration in which a detection circuit 20 that detects photons incident on a SPAD element 10 includes a photon detection unit 30, a counter 40, a hold pulse generation unit 50, a storage unit 60, and a selection control unit 70.

In the detection circuit 20 having the above-described configuration, the configurations of the photon detection unit 30, the counter 40, the hold pulse generation unit 50, and the selection control unit 70 are the same as those of the first embodiment, and the configuration of the storage unit 60 is different from that of the first embodiment. Specifically, the storage unit 60 includes a read control unit 63 in addition to the first storage unit 61 and the second storage unit 62 constructed by utilizing, for example, memories.

The read control unit 63 performs control to generate read control signals RD1 and RD2, read a hold value REG1 by applying the read control signal RD1 to the first storage unit 61, and read a hold value REG2 by applying the read control signal RD2 to the second storage unit 62 at a timing different from the read control signal RD1.

### [Example of Circuit Operation of Pixel]

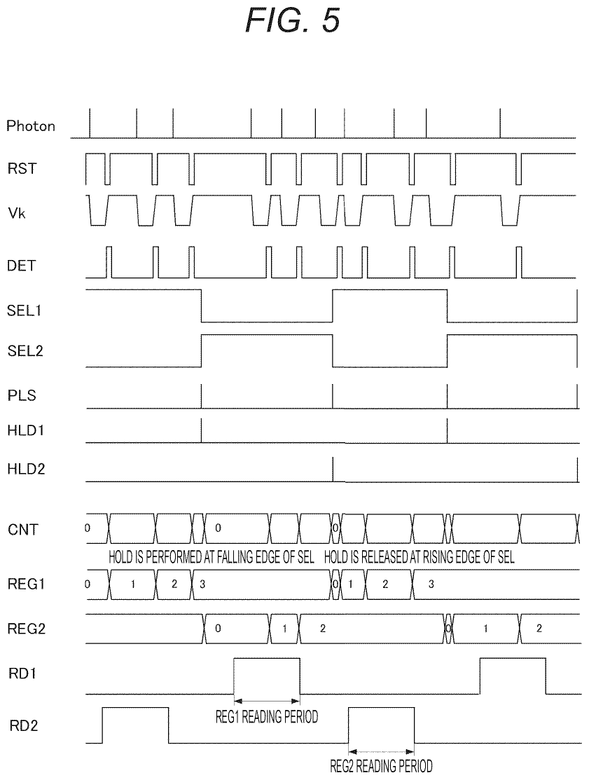

An example of a circuit operation of the pixel 2 according to the second embodiment of the above-described configuration will be described. FIG. 5 is a timing chart for explaining an example of the circuit operation of the pixel 2 of the imaging element 1 according to the second embodiment. Here, the timing relationship in one exposure period is illustrated.

FIG. 5 illustrates a timing relationship among the reset pulse RST, the cathode voltage Vk of the SPAD element 10, the detection pulse DET, the selection pulses SEL1 and SEL2, the hold pulse PLS, the hold signals HLD1 and HLD2, the count value CNT, the hold values REG1 and REG2, and the read control signals RD1 and RD2 with respect to incident photons.

As illustrated in the timing chart of FIG. 5, under the control of the hold signals HLD1 and HLD2, in the first storage unit 61 and the second storage unit 62 alternately perform holding of the count value CNT of the counter 40 twice in one exposure period. In this instance, the hold is performed at the falling edge of the selection pulse SEL (SEL1 and SEL2), and the hold is released at the rising edge. Thereafter, under the control of the read control signals RD1 and RD2 output from the read control unit 63 at different timings, during a period in which one of the first storage unit 61 and the second storage unit 62 performs holding, reading the hold value REG1 or REG2 of the other one is performed.

As described above, in the imaging element 1 according to the second embodiment, the circuit operation is performed, in one exposure period, to alternately switch the hold period with respect to the first storage unit 61 and the second storage unit 62, so that an increase in the count value CNT of the counter 40 is always reflected in one of the storage units. Then, during the period in which one of the first storage unit 61 and the second storage unit 62 performs holding, a so-called pipeline operation of reading the hold values REG1 or REG2 of the other one is performed. With this pipeline operation, it is possible to minimize the interruption of the exposure during a read period in a global shutter operation of simultaneously scanning all regions of an image.

### Third Embodiment

A third embodiment of the present technology is an example of the configuration of a plurality of storage units with a counter, and counting the number of detected photons by the plurality of storage units.

### [Example of Circuit Configuration of Pixel]

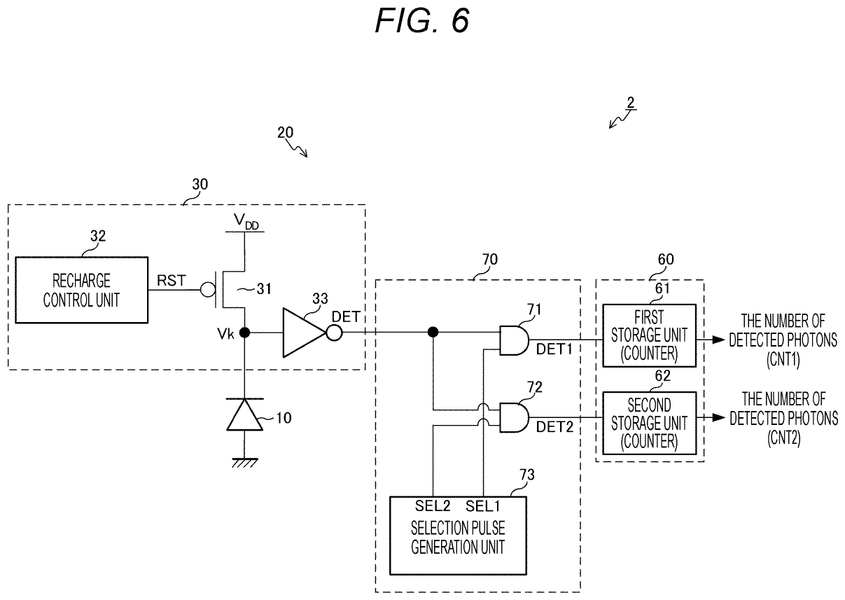

FIG. 6 is a block diagram illustrating an example of a circuit configuration of a pixel 2 of an imaging element 1 according to a third embodiment of the present technology.

The pixel 2 of the imaging element 1 according to the third embodiment has the configuration in which a detection circuit 20 that detects photons incident on a SPAD element 10 includes a photon detection unit 30, a storage unit 60, and a selection control unit 70. In the detection circuit 20 having this configuration, the configuration of the photon detection unit 30 is the same as that of the first embodiment.

The storage unit 60 includes, for example, two storage units of a first storage unit 61 and a second storage unit 62. In the third embodiment, the first storage unit 61 and the second storage unit 62 are constructed by utilizing, for example, counters. That is, in the third embodiment, the first storage unit 61 and the second storage unit 62 constructed by utilizing counters are configured to count a detection pulse DET generated by the photon detection unit 30, that is, count the number of detected photons.

A count value CNT1 of the first storage unit 61 and a count value CNT2 of the second storage unit 62 correspond to the number of detected photons detected by the photon detection unit 30, and are output as pixel signals corresponding to photons incident on the SPAD element 10 during a predetermined exposure period.

In the selection control unit 70, the 2-input first AND circuit 71 receives a detection pulse DET generated by a photon detection unit 30 as one input and a selection pulse SEL1 generated by a selection pulse generation unit 73 as the other input, and outputs a first detection pulse DET1 on the basis of these two inputs. This first detection pulse DET1 is counted by a counter constituting the first storage unit 61. The count value CNT1 of the first storage unit 61 is output as a pixel signal corresponding to the number of detected photons in a predetermined exposure period.

The 2-input second AND circuit 72 receives a detection pulse DET generated by the photon detection unit 30 as one input and a selection pulse SEL2 generated by the selection pulse generation unit 73 as the other input, and outputs a second detection pulse DET2 on the basis of these two inputs. This second detection pulse DET2 is counted by a counter constituting the second storage unit 62. The count value CNT2 of the second storage unit 62 is output as a pixel signal corresponding to the number of detected photons in a predetermined exposure period.

The selection pulse generation unit 73 generates selection pulses SEL1 and SEL2 for selecting one of the plurality of storage units of the storage unit 60, as a storage unit that stores the detection pulse DET corresponding to the number of detected photons, in present example, the first storage unit 61 or the second storage unit 62, and provides the selection pulses SEL1 and SEL2 to the first AND circuit 71 and the second AND circuit 72 as the other inputs.

### [Example of Circuit Operation of Pixel]

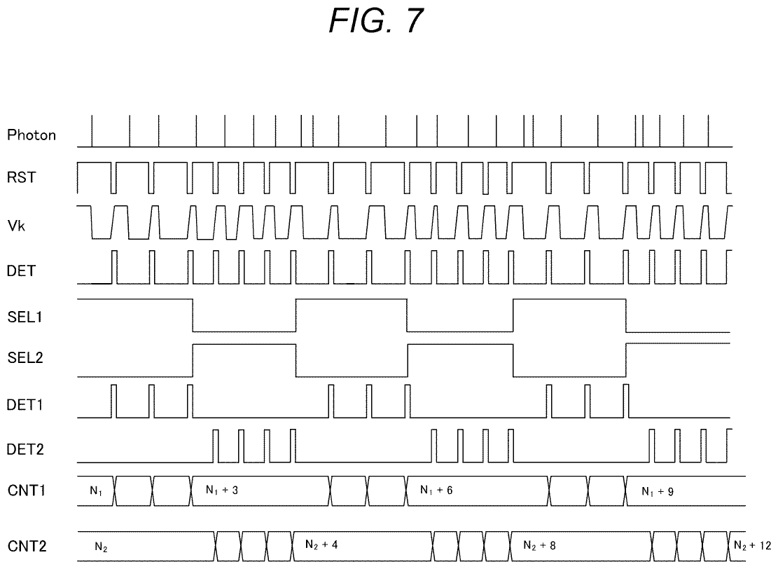

An example of a circuit operation of the pixel 2 according to the third embodiment of the above-described configuration will be described. FIG. 7 is a timing chart for explaining an example of the circuit operation of the pixel 2 of the imaging element 1 according to the third embodiment.

FIG. 7 illustrates a timing relationship among the reset pulse RST, the cathode voltage Vk of the SPAD element 10, the detection pulse DET, the selection pulses SEL1 and SEL2, the first and second detection pulses DET1 and DET 2, and the first and second count values CNT1 and CNT2 with respect to incident photons.

As illustrated in the timing chart of FIG. 7, in the imaging element 1 according to the third embodiment, switching between the first storage unit 61 and the second storage unit 62 is repeated a plurality of times under the control of the selection pulses SEL1 and SEL2. Then, regarding the counting of the number of detected photons by respective counters constituting the first storage unit 61 and the second storage unit 62, specifically, the counting of the first count value CNT1 and the second count value CNT2, a period in which the counting operation is performed and a period in which the counting operation is not performed are repeated a plurality of times. The count value CNT1 and count value CNT2 of the first storage unit 61 and second storage unit 62 are output as pixel signals corresponding to the number of detected photons in a predetermined exposure period.

As described above, in the imaging element 1 according to the third embodiment, the period in which the counting operation is performed and the period in which the counting operation is not performed for the number of detected photons are repeated a plurality of times in the respective counters constituting the first storage unit 61 and the second storage unit 62 while the switching between the first storage unit 61 and the second storage unit 62 is repeated a plurality of times. As a result, the light-receiving periods in the respective counters constituting the first storage unit 61 and the second storage unit 62 can be dispersed, it is possible to obtain simultaneously an imaging result to which an electronic neutral density (ND) filter is applied and an imaging result obtained by normal exposure.

### Fourth Embodiment

A fourth embodiment of the present technology is an example of synchronizing the switching of a period of recharge control (hereinbelow, which may be simply referred to as “recharge period”) and the operation of selecting one of a plurality of storage units in the configuration of the first embodiment.

### [Example of Circuit Configuration of Pixel]

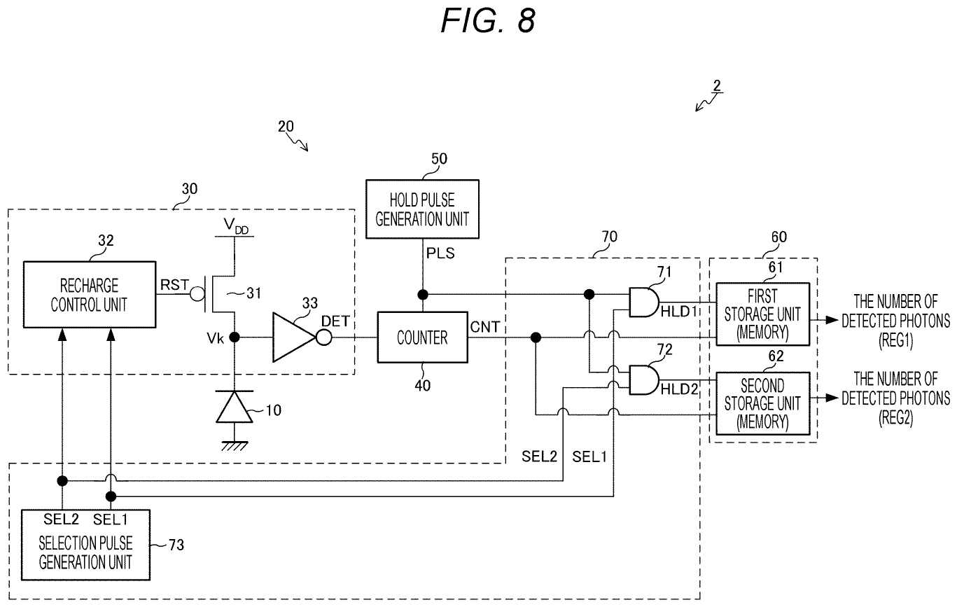

FIG. 8 is a block diagram illustrating an example of a circuit configuration of a pixel 2 of an imaging element 1 according to a fourth embodiment of the present technology.

Similar to the case of the first embodiment, the pixel 2 of the imaging element 1 according to the fourth embodiment has the configuration in which a detection circuit 20 that detects photons incident on a SPAD element 10 includes a photon detection unit 30, a counter 40, a hold pulse generation unit 50, a storage unit 60, and a selection control unit 70. The configurations of the photon detection unit 30, the counter 40, the hold pulse generation unit 50, the storage unit 60, and the selection control unit 70 are the same as those in the first embodiment. Furthermore, in the storage unit 60, a first storage unit 61 and a second storage unit 62 are constructed by utilizing memories.

The imaging element 1 according to the fourth embodiment having the above-described configuration is different from the case of the first embodiment in that the switching of a period of recharge control in a recharge control unit 32 is synchronized with the operation of selecting one of a plurality of storage units (first storage unit 61 and second storage unit 62). Here, the period of the recharge control is a period of a reset pulse RST output from the recharge control unit 32 that recharges a SPAD element 10. The reset pulse RST can also be referred to as a recharge pulse.

A selection pulse generation unit 73 generates selection pulses SEL1 and SEL2 for selecting the first storage unit 61 or the second storage unit 62, as a storage unit that stores a count value CNT of a counter 40 corresponding to the number of detected photons, and supplies the selection pulses SEL1 and SEL2 to the first AND circuit 71 and the second AND circuit 72. The selection pulse generation unit 73 further supplies the selection pulses SEL1 and SEL2 to the recharge control unit 32.

The recharge control unit 32 generates a reset pulse RST having a plurality of different periods on the basis of the selection pulses SEL1 and SEL2 supplied from the selection pulse generation unit 73. Specifically, the recharge control unit 32 switches the period of the reset pulse RST, that is, switches the period of the recharge control on the basis of the selection pulses SEL1 and SEL2. As a result, the switching of the period of the recharge control and the operation of selecting the first storage unit 61 or the second storage unit 62 are synchronized.

The first storage unit 61 stores a count value CNT output from the counter 40 under the control of the hold signal HLD1 applied from the first AND circuit 71. A hold value REG1 of the first storage unit 61 corresponds to the number of detected photons detected by the photon detection unit 30, and is output as a pixel signal corresponding to photons incident on the SPAD element 10 during a predetermined exposure period.

The second storage unit 62 stores a count value CNT output from the counter 40 under the control of the hold signal HLD2 applied from the second AND circuit 72. A hold value REG2 of the second storage unit 62 corresponds to the number of detected photons detected by the photon detection unit 30, and is output as a pixel signal corresponding to photons incident on the SPAD element 10 during a predetermined exposure period.

### [Example of Circuit Operation of Pixel]

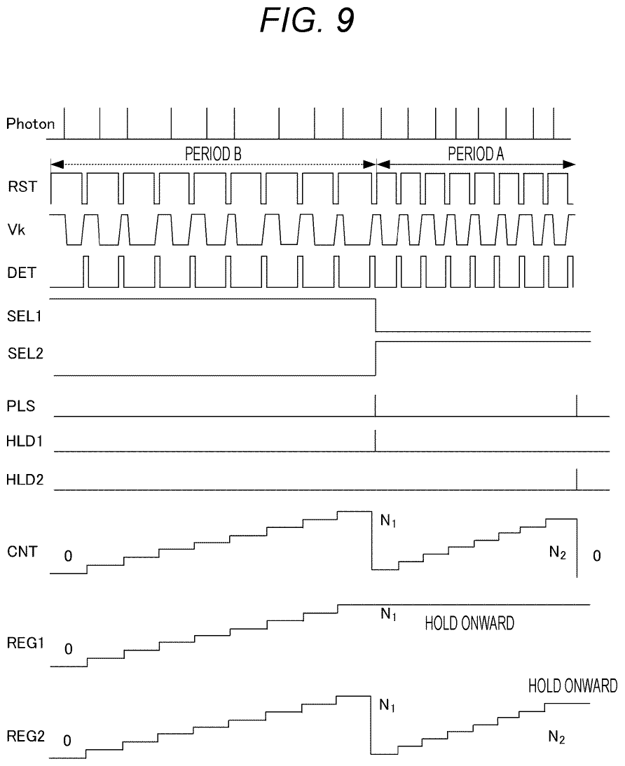

An example of a circuit operation of the pixel 2 according to the fourth embodiment of the above-described configuration will be described. FIG. 9 is a timing chart for explaining an example of the circuit operation of the pixel 2 of the imaging element 1 according to the fourth embodiment.

FIG. 9 illustrates a timing relationship among the reset pulse RST, the cathode voltage Vk of the SPAD element 10, the detection pulse DET, the selection pulses SEL1 and SEL2, the hold pulse PLS, the hold signals HLD1 and HLD2, the count value CNT, and the hold values REG1 and REG2 with respect to incident photons.

As illustrated in the timing chart of FIG. 9, the switching of the period of the recharge control, that is in present example, the switching from a period B of the long recharge period to a period A of the short recharge period is performed at the timing of logical switching of the selection pulses SEL1 and SEL2. Then, a circuit operation is performed in which in the period B in which the selection pulse SEL1 is at the high level and the selection pulse SEL2 is at the low level, the first storage unit 61 stores a count value N1 of the counter 40, and in the period A in which the selection pulse SEL1 is at the low level and the selection pulse SEL2 is at the high level, the second storage unit 62 stores a count value N2 of the counter 40.

As described above, in the imaging element 1 according to the fourth embodiment, the input of the count value CNT of the counter 40 to the first storage unit 61 and the second storage unit 62 constructed by utilizing memories is synchronized with the switching of the period of the reset pulse RST. As a result, the first storage unit 61 and the second storage unit 62 can store the count value N1 and the count value N2 of the counter 40 under the different levels of incident illuminance in addition to different exposure periods. As a result, the gamma curve (input/output characteristics) can be adjusted after reading the count values without losing a SN ratio obtained in a case where the exposure is carried out with a single storage unit.

As in the fourth embodiment described above, photon detection is performed by recharge control with a plurality of periods, a plurality of storage units that store the number of detected photons is provided, and the switching of the period of the recharge control and the switching of the storage unit that stores the number of detected photons are synchronized; thereby the following effect and result can be obtained. That is, since the count values of the number of detected photons from a plurality of different input/output characteristics can be obtained by one exposure, it is possible to derive (estimate) the correct number of incident photons even in a case where the incident illuminance changes over time during the exposure period.

Here, the following two points will be described:
(1) a method of estimating incident illuminance from count values of different input/output characteristics; and
(2) a method of acquiring a count value by a plurality of input/output characteristics.
   [Method of Estimating Incident Illuminance from Count Values of Different Input/Output Characteristics]

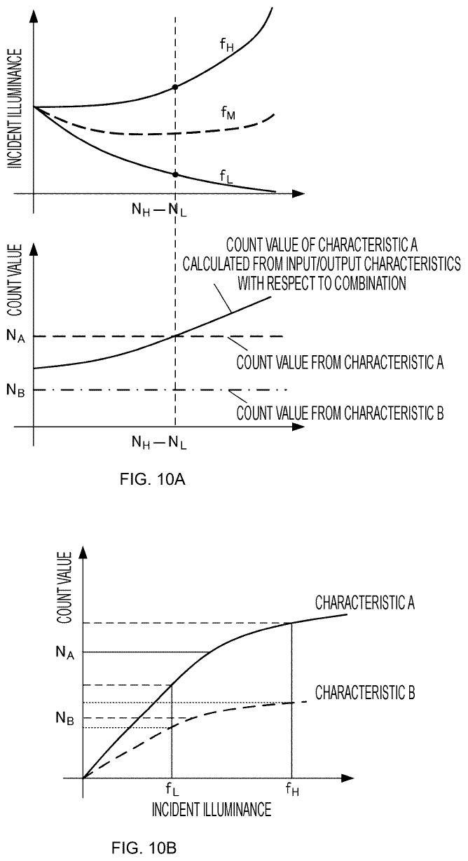

FIG. 10 is a diagram for explaining a method of estimating incident illuminance from count values of different input/output characteristics in the fourth embodiment of the present technology. In FIG. 10, a is a diagram for explaining a combination of incident illuminances f_{H} and f_{L} to achieve a count value N_{B} of the number of detected photons from an input/output characteristic B, and in the same figure, b is a diagram for explaining illuminance change to acquire a count value N_{A} of the number of detected photons from an input/output characteristic A and the count value N_{B} of the number of detected photons from the input/output characteristic B.

It is assumed that the count values N_{A} and N_{B} of the number of detected photons are obtained by the two input/output characteristics A and B. Assuming that the illuminance change occurs in the middle of the exposure period, the incident illuminance f_{H} in the leading half of the exposure period and the incident illuminance f_{L} in the trailing half of the exposure period can be estimated.

First, a combination of the incident illuminances f_{H} and f_{L} to achieve the count value N_{B} is obtained. On the basis of the known input/output characteristics per unit time of the input/output characteristic A, a count value of the number of detected photons from the input/output characteristic A is calculated for each combination of the incident illuminances f_{H} and f_{H} obtained. In this instance, the combination of f_{H} and f_{L} to acquire the count value N_{A} of the number of detected photons actually obtained is the incident illuminance.

[Method of Acquiring Count Value of the Number of Detected Photons from Plurality of Input/Output Characteristics]

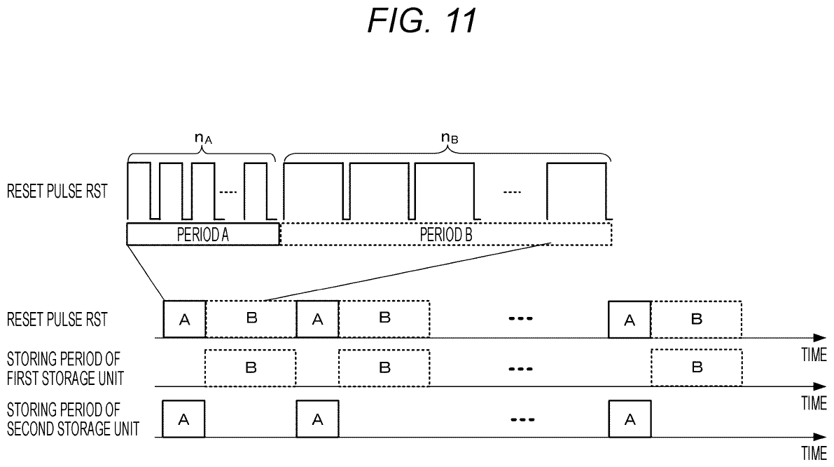

FIG. 11 is a diagram for explaining a method of acquiring the count values of the number of detected photons from the plurality of input/output characteristics in the fourth embodiment of the present technology.

In the recharge control with a plurality of periods, the reset pulse RST is supplied from the recharge control unit 32 while a plurality of different periods is switched over time. In this instance, the plurality of storage units that store the detection pulse DET generated by the photon detection unit 30 is prepared, and the switching of the plurality of storage units is synchronized with the period of the reset pulse RST supplied from the recharge control unit 32.

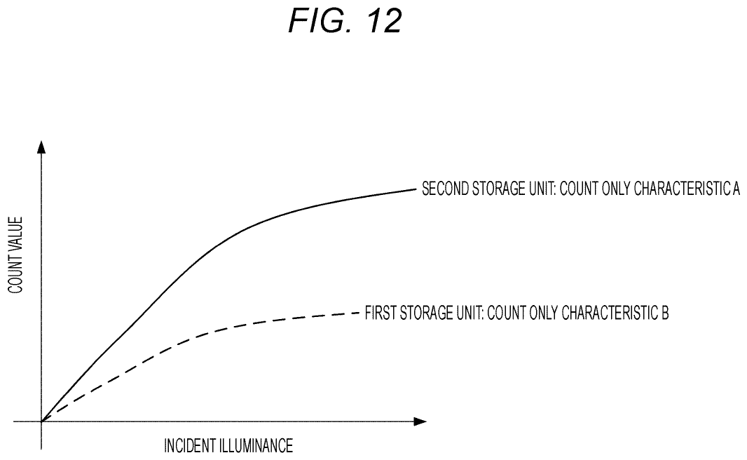

Specifically, for example, in a case where the reset pulse RST is supplied while the periods of the period A and the period B are switched, two storage units of the first storage unit 61 and the second storage unit 62 are prepared as the storage unit 60. Then, the switching between the storage units is performed so that the first storage unit 61 stores the count value of the number of detected photons only during the period B, and the second storage unit 62 stores the count value of the number of detected photons only during the period A. By performing such an operation, it is possible to acquire the different input/output characteristics A and B for respective storage units (first storage unit 61/second storage unit 62) as illustrated in FIG. 12. Then, the first storage unit 61 obtains a count value n_{B} of the number of detected photons from the input/output characteristic B, and the second storage unit 62 obtains a count value n_{A} of the number of detected photons from the input/output characteristic A.

### [Technology According to Reference Example]

Here, a case where the count value of the number of detected photons is nonlinear with respect to the number of incident photons per unit time will be described as a technology according to a reference example. As a problem of the technology according to this reference example, it is difficult to derive the correct number of incident photons in a case where there is a temporal change in the incident illuminance due to the nonlinear input/output characteristics. A reason for this is hereinafter described.

The count value of the number of detected photons obtained by exposure for a certain period is obtained by integrating input/output characteristics per unit time with respect to time. In a case where there is no temporal change in the incident illuminance during the exposure period, the input/output characteristics per unit time are maintained provided that the count value is divided by the exposure time, and the number of incident photons can be thus derived from the count value of the number of detected photons.

On the other hand, in a case where there is a temporal change in the incident illuminance during the exposure period, the count value of the same number of detected photons may be acquired even though the number of incident photons varies due to the non-linearity of the input/output characteristics. Therefore, the number of incident photons cannot be correctly derived from the count value of the number of detected photons.

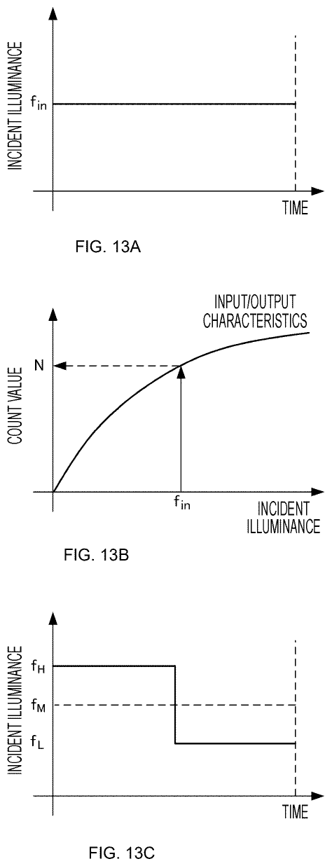

For example, in a case where there is no change in the incident illuminance as illustrated in a of FIG. 13 in a certain exposure period, the count value of the number of detected photons with respect to the incident illuminance is a constant multiple of the input/output characteristics per unit time as illustrated in b of FIG. 13. The number of incident photons can be derived from the count value of the number of detected photons because the incident illuminance and the count value of the number of detected photons correspond one-to-one.

On the other hand, as an example of a case where there is a change in illuminance, it is considered that the incident illuminance is switched to the high illuminance in the leading half of the exposure period and is switched to the low illuminance in the trailing half as illustrated in c of FIG. 13. In this case, the count value of the number of detected photons is increased by a count value NH of the number of detected photons due to an incident illuminance f_{H} in the leading half of the exposure period, and the count value of the number of detected photons is increased by a count value NL of the number of detected photons due to an incident illuminance f_{L} in the trailing half of the exposure period, resulting in a count value Nₒᵤₜ=N_{H}+N_{L} of the number of detected photons.

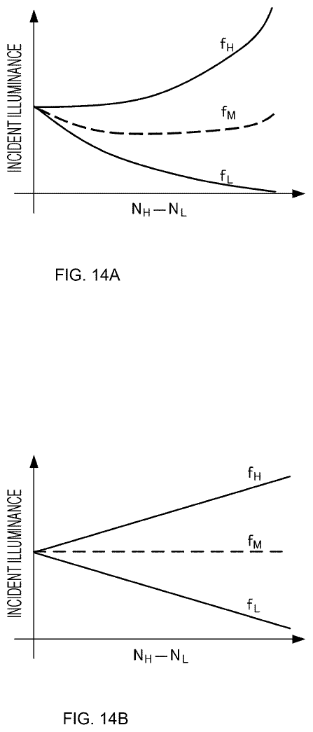

The number of incident photons cannot be derived from the count value Nₒᵤₜ of the number of detected photons obtained in this instance. For example, it is assumed that the illuminance change is known, and only the incident illuminances f_{H} and f_{L} are unknown. Since the number of incident photons is proportional to the average illuminance f_{M}, it is only required to found f_{M}=(f_{H}+f_{L})/2. However, combinations of the incident illuminances f_{H} and f_{L} for acquiring the count value Nₒᵤₜ of the number of detected photons and the average illuminance f_{M} corresponding thereto are innumerable and are not uniquely determined. This is a problem peculiar to the case of the nonlinear input/output characteristics as illustrated in a of FIG. 14. This is because, as illustrated in b of FIG. 14, in a case where the input/output characteristics are linear, there are innumerable combinations of the incident illuminances f_{H} and f_{L}, but the average illuminance f_{M} is all equal.

Similarly in the real case where the illuminance change is unknown and more complicated, it is not feasible that the correct number of incident photons is derived because the correct number of incident photons is unknown even though the illuminance change has been known.

### Fifth Embodiment

A fifth embodiment of the present technology is an example of synchronizing the switching of a period of recharge control and the operation of selecting one of a plurality of storage units in the configuration of the third embodiment.

### [Example of Circuit Configuration of Pixel]

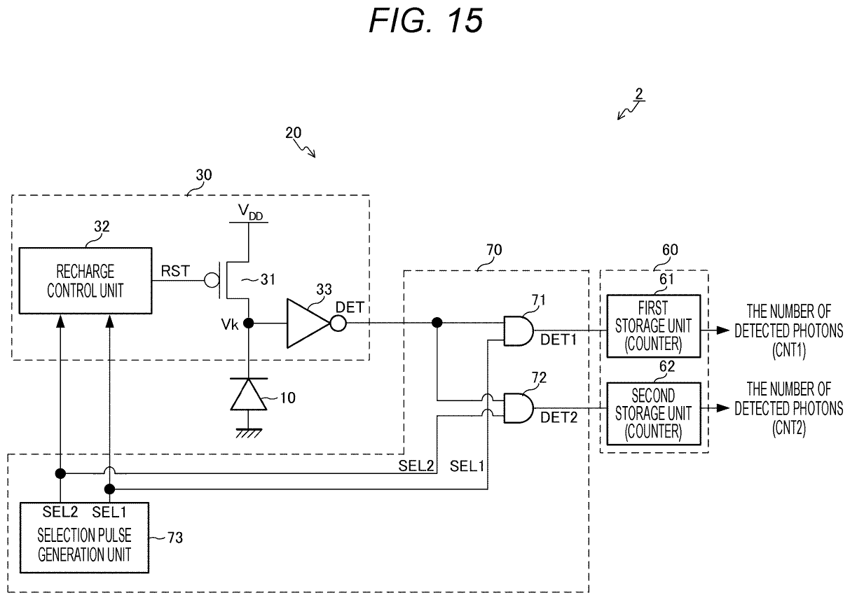

FIG. 15 is a block diagram illustrating an example of a circuit configuration of a pixel 2 of an imaging element 1 according to the fifth embodiment of the present technology.

Similar to the case of the third embodiment, the pixel 2 of the imaging element 1 according to the fifth embodiment has the configuration in which a detection circuit 20 that detects photons incident on a SPAD element 10 includes a photon detection unit 30, a storage unit 60, and a selection control unit 70. The configuration of the photon detection unit 30 is the same as that of the first embodiment. Furthermore, in the storage unit 60, a first storage unit 61 and a second storage unit 62 are constructed by utilizing counters.

The imaging element 1 according to the fifth embodiment having the above-described configuration is different from the case of the third embodiment in that the switching of a period of recharge control in a recharge control unit 32 is synchronized with the operation of selecting one of a plurality of storage units (first storage unit 61 and second storage unit 62).

A selection pulse generation unit 73 generates selection pulses SEL1 and SEL2 for selecting the first storage unit 61 or the second storage unit 62, as a storage unit that stores the number of detected photons generated by the photon detection unit 30, and supplies the selection pulses SEL1 and SEL2 to the first AND circuit 71 and the second AND circuit 72. The selection pulse generation unit 73 further supplies the selection pulses SEL1 and SEL2 to the recharge control unit 32.

The recharge control unit 32 generates a reset pulse RST having a plurality of different periods on the basis of the selection pulses SEL1 and SEL2 supplied from the selection pulse generation unit 73. Specifically, the recharge control unit 32 switches the period of the reset pulse RST, that is, switches the period of the recharge control on the basis of the selection pulses SEL1 and SEL2. As a result, the switching of the period of the recharge control and the operation of selecting the first storage unit 61 or the second storage unit 62 are synchronized.

In the selection control unit 70, the 2-input first AND circuit 71 receives a detection pulse DET generated by a photon detection unit 30 as one input and a selection pulse SEL1 generated by a selection pulse generation unit 73 as the other input, and outputs a first detection pulse DET1 on the basis of these two inputs. This first detection pulse DET1 is counted by a counter constituting the first storage unit 61. The count value CNT1 of the first storage unit 61 is output as a pixel signal corresponding to the number of detected photons in a predetermined exposure period.

The 2-input second AND circuit 72 receives a detection pulse DET generated by the photon detection unit 30 as one input and a selection pulse SEL2 generated by the selection pulse generation unit 73 as the other input, and outputs a second detection pulse DET2 on the basis of these two inputs. This second detection pulse DET2 is counted by a counter constituting the second storage unit 62. The count value CNT2 of the second storage unit 62 is output as a pixel signal corresponding to the number of detected photons in a predetermined exposure period.

### [Example of Circuit Operation of Pixel]

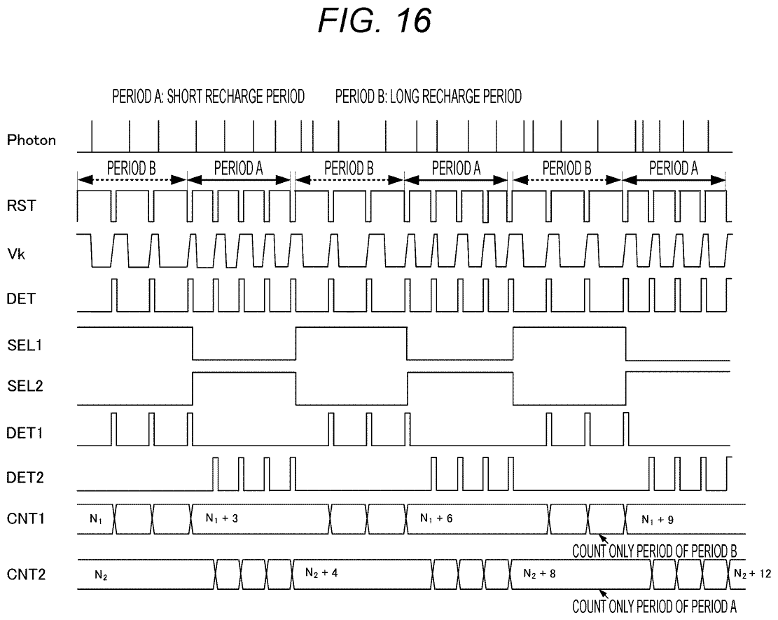

An example of a circuit operation of the pixel 2 according to the fifth embodiment of the above-described configuration will be described. FIG. 16 is a timing chart for explaining an example of the circuit operation of the pixel 2 of the imaging element 1 according to the fifth embodiment.

FIG. 16 illustrates a timing relationship among the reset pulse RST, the cathode voltage Vk of the SPAD element 10, the detection pulse DET, the selection pulses SEL1 and SEL2, the first and second detection pulses DET1 and DET 2, and the first and second count values CNT1 and CNT2 with respect to incident photons.

As illustrated in the timing chart of FIG. 16, in the imaging element 1 according to the fifth embodiment, the switching of the period of the recharge control, that is in present example, the switching from a period B of the long recharge period to a period A of the short recharge period is performed at the timing of logical switching of the selection pulses SEL1 and SEL2. Then, the respective counters constituting the first storage unit 61 and the second storage unit 62 count the number of detected photons through repeating the switching between the first storage unit 61 and the second storage unit 62 under the control of the selection pulses SEL1 and SEL2. The count value CNT1 and count value CNT2 of the first storage unit 61 and second storage unit 62 are output as pixel signals corresponding to the number of detected photons in a predetermined exposure period.

As described above, in the imaging element 1 according to the fifth embodiment, the input of the detection pulse DET generated by the photon detection unit 30 to the first storage unit 61 and the second storage unit 62 constructed by utilizing counters is synchronized with the switching of the period of the reset pulse RST. Therefore, the exposure result from a plurality of different input/output characteristics in the same exposure period can be obtained without bias in the exposure period. As a result, since the illuminance change during the exposure can be estimated from the count value of the number of detected photons in the plurality of input/output characteristics, it is possible to respond to the change in the illuminance of faster-moving objects.

### Sixth Embodiment

A sixth embodiment of the present technology is an example of switching a plurality of storage units on the basis of a signal for switching a period of recharge control (recharge period) in the configuration of the third embodiment. Similar to the fourth embodiment, also in present example, synchronizing the switching of the period of the recharge control and the operation of selecting one of the plurality of storage units can be achieved.

### [Example of Circuit Configuration of Pixel]

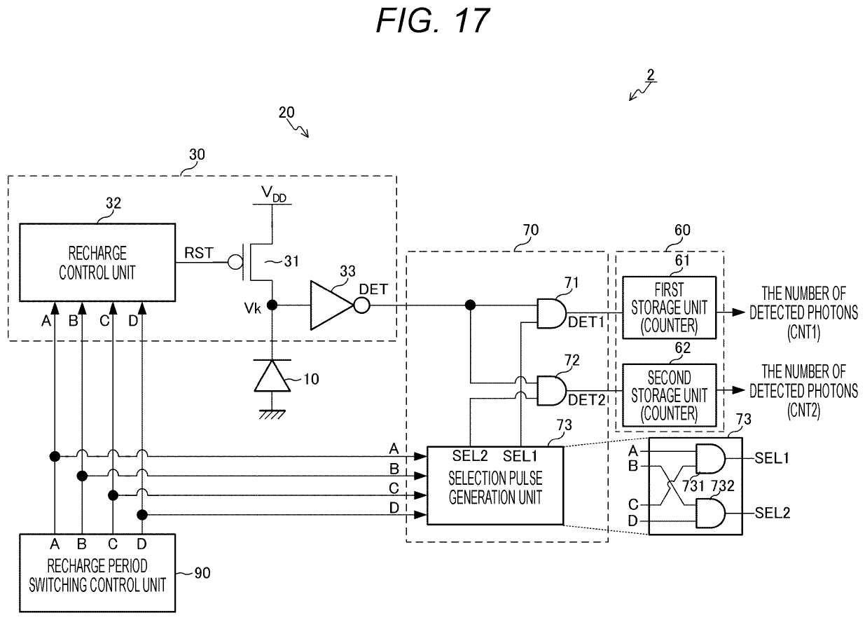

FIG. 17 is a block diagram illustrating an example of a circuit configuration of a pixel 2 of an imaging element 1 according to the sixth embodiment of the present technology.

Similar to the case of the third embodiment, the pixel 2 of the imaging element 1 according to the sixth embodiment has the configuration in which a detection circuit 20 that detects photons incident on a SPAD element 10 includes a photon detection unit 30, a storage unit 60, and a selection control unit 70. The configuration of the photon detection unit 30 is the same as that of the first embodiment. Furthermore, in the storage unit 60, a first storage unit 61 and a second storage unit 62 are constructed by utilizing counters.

The imaging element 1 according to the sixth embodiment includes a recharge period switching control unit 90 in addition to the photon detection unit 30, the storage unit 60, and the selection control unit 70. The recharge period switching control unit 90 generates four types of switching signals A, B, C, and D for switching a period of a reset signal RST output from a recharge control unit 32, that is, a recharge period, and provides the switching signals A, B, C, and D to the recharge control unit 32.

The recharge control unit 32 generates a reset signal RST with four types of a period A, a period B, a period C, and a period D on the basis of the recharge period switching signals A, B, C, and D provided from the recharge period switching control unit 90. In other words, in the recharge control unit 32, switching the periods of the reset signal RST to be generated is carried out on the basis of the recharge period switching signals A, B, C, and D.

The recharge period switching control unit 90 further provides the generated recharge period switching signals A, B, C, and D to the selection pulse generation unit 73 of the selection control unit 70. The selection pulse generation unit 73 generates selection pulses SEL1 and SEL2 for selecting the first storage unit 61 or the second storage unit 62 as storage units that store (count) the number of detected photons on the basis of the charge period switching signals A, B, C, and D provided from the recharge period switching control unit 90. The Selection pulses SEL1 and SEL2 generated by the selection pulse generation unit 73 are provided to the first AND circuit 71 and the second AND circuit 72.

The selection pulse generation unit 73 can include a logic circuit therein. Specifically, as illustrated in the lower right of FIG. 17, the selection pulse generation unit 73 can include two 2-input AND circuits 731 and 732. One AND circuit 731 receives two inputs of a switching signal A and a switching signal C to generate a selection pulse SEL1. The other AND circuit 732 receives two inputs of a switching signal B and a switching signal D to generate a selection pulse SEL2.

In this way, by generating the selection pulses SEL1 and SEL2 for selecting the first storage unit 61 or the second storage unit 62 on the basis of the recharge period switching signals A, B, C, and D, it is possible to synchronize the switching of the period of the recharge control with the operation of selecting the first storage unit 61 or the second storage unit 62.

In the selection control unit 70, the 2-input first AND circuit 71 receives a detection pulse DET generated by a photon detection unit 30 as one input and a selection pulse SEL1 generated by a selection pulse generation unit 73 as the other input, and outputs a first detection pulse DET1 on the basis of these two inputs. The first detection pulse DET1 is counted by a counter constituting the first storage unit 61. The count value CNT1 of the first storage unit 61 is output as a pixel signal corresponding to the number of detected photons in a predetermined exposure period.

The 2-input second AND circuit 72 receives a detection pulse DET generated by the photon detection unit 30 as one input and a selection pulse SEL2 generated by the selection pulse generation unit 73 as the other input, and outputs a second detection pulse DET2 on the basis of these two inputs. The second detection pulse DET2 is counted by a counter constituting the second storage unit 62. The count value CNT2 of the second storage unit 62 is output as a pixel signal corresponding to the number of detected photons in a predetermined exposure period.

### [Example of Circuit Operation of Pixel]

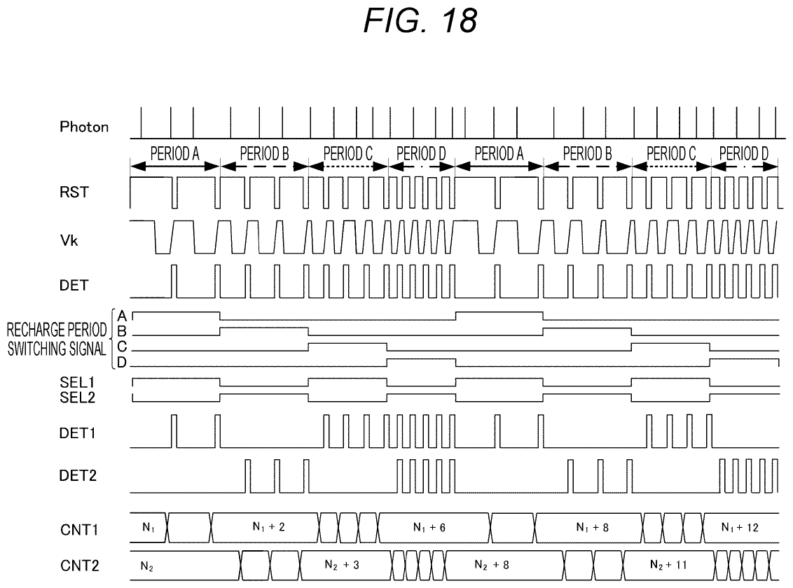

An example of a circuit operation of the pixel 2 according to the sixth embodiment of the above-described configuration will be described. FIG. 18 is a timing chart for explaining an example of the circuit operation of the pixel 2 of the imaging element 1 according to the sixth embodiment.

FIG. 18 illustrates a timing relationship among the reset pulse RST, the cathode voltage Vk of the SPAD element 10, the detection pulse DET, the recharge period switching signals A, B, C, D, the selection pulses SEL1 and SEL2, the first and second detection pulses DET1 and DET 2, and the first and second count values CNT1 and CNT2 with respect to incident photons.

As illustrated in the timing chart of FIG. 18, in the imaging element 1 according to the sixth embodiment, in the recharge control unit 32, four types of the recharge periods of the period A, period B, period C, and period D are set on the basis of four types of the recharge period switching signals A, B, C, and D as the periods of the reset pulse RST. Specifically, the period A is set in the high-level period of the switching signal A, the period B is set in the high-level period of the switching signal B, the period C is set in the high-level period of the switching signal C, and the period D is set in the high-level period of the switching signal D. Here, the relationship between the long and short periods of the reset pulse RST is, for example, the period A>the period B>the period C>the period D.

Furthermore, in the selection pulse generation unit 73 of the selection control unit 70, the selection pulse SEL1 at the high level is generated in a period in which the recharge period switching signals A and C are at the high level, and the selection pulse SEL2 at the high level is generated in a period in which the recharge period switching signals B and D are at the high level. As a result, the logical switching of the Selection pulses SEL1 and SEL2 is performed at the timing of switching the recharge period.

Then, the respective counters constituting the first storage unit 61 and the second storage unit 62 count the number of detected photons through repeating the switching between the first storage unit 61 and the second storage unit 62 under the control of the selection pulses SEL1 and SEL2. The count value CNT1 and count value CNT2 of the first storage unit 61 and second storage unit 62 are output as pixel signals corresponding to the number of detected photons in a predetermined exposure period.

As described above, in the imaging element 1 according to the sixth embodiment, the switching of the periods of the reset pulse RST and the switching between the first storage unit 61 and the second storage unit 62 are synchronized on the basis of the recharge period switching signals A, B, C, and D. As a result, in the respective counters of the first storage unit 61 and the second storage unit 62, the count values CNT1 and CNT2 of the number of detected photons in a plurality of recharge periods with the periods being different from each other can be stored. As a result, since the number of detected photons can be counted with a combination of the long and short recharge periods, the dynamic range of the input/output characteristics in each counter can be expanded.

### Seventh Embodiment

A seventh embodiment of the present technology is an example of generating selection pulses SEL1 and SEL2 for switching between a plurality of storage units in a recharge control unit 32 generating a reset pulse RST. Similar to the fourth embodiment, also in present example, synchronizing the switching of the period of the recharge control and the operation of selecting one of the plurality of storage units can be achieved.

### [Example of Circuit Configuration of Pixel]

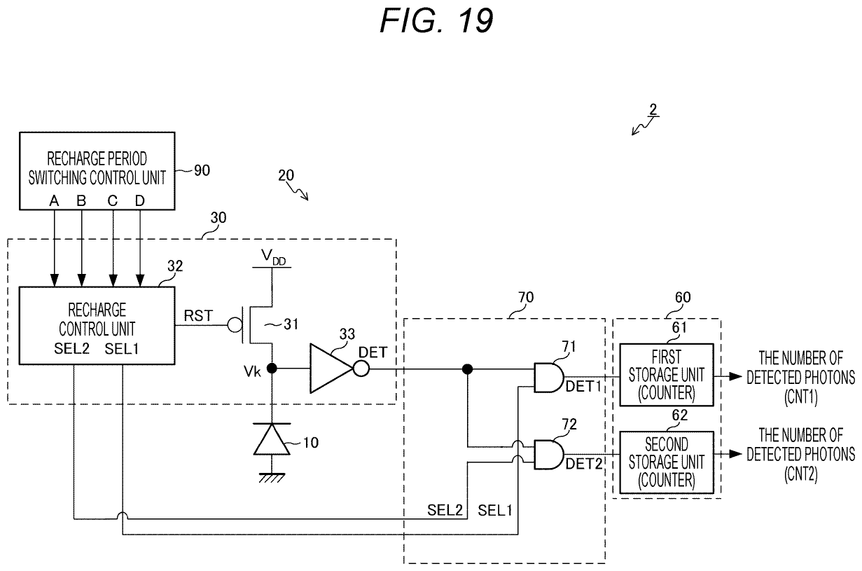

FIG. 19 is a block diagram illustrating an example of a circuit configuration of a pixel 2 of an imaging element 1 according to the seventh embodiment of the present technology.

The pixel 2 of the imaging element 1 according to the seventh embodiment has a configuration in which a selection pulse generation unit 73 generates selection pulses SEL1 and SEL2 for selecting a first storage unit 61 or a second storage unit 62, and another configuration is basically the same as in the seventh embodiment that the first storage unit 61 and the second storage unit 62 are constructed by utilizing counters.

Specifically, in the pixel 2 of the imaging element 1 according to the seventh embodiment, the recharge control unit 32 generates a reset signal RST with a plurality of periods on the basis of four types of switching signals A, B, C, and D for switching a recharge period provided from a recharge period switching control unit 90. In other words, in the recharge control unit 32, switching the periods of the reset signal RST to be generated is carried out on the basis of the recharge period switching signals A, B, C, and D.

The recharge control unit 32 further generates selection pulses SEL1 and SEL2 for selecting the first storage unit 61 or the second storage unit 62 as storage units that store (count) the number of detected photons on the basis of the recharge period switching signals A, B, C, and D provided from the recharge period switching control unit 90. The selection pulses SEL1 and SEL2 generated by the recharge control unit 32 are provided to the first AND circuit 71 and the second AND circuit 72.

In this way, in the recharge control unit 32 that generates the reset pulse RST, by generating the selection pulses SEL1 and SEL2 for switching between the plurality of storage units, that is, switching between the first storage unit 61 and the second storage unit 62, it is possible to synchronize the switching of the period of the recharge control with the operation of selecting the first storage unit 61 or the second storage unit

### [Example of Circuit Operation of Pixel]

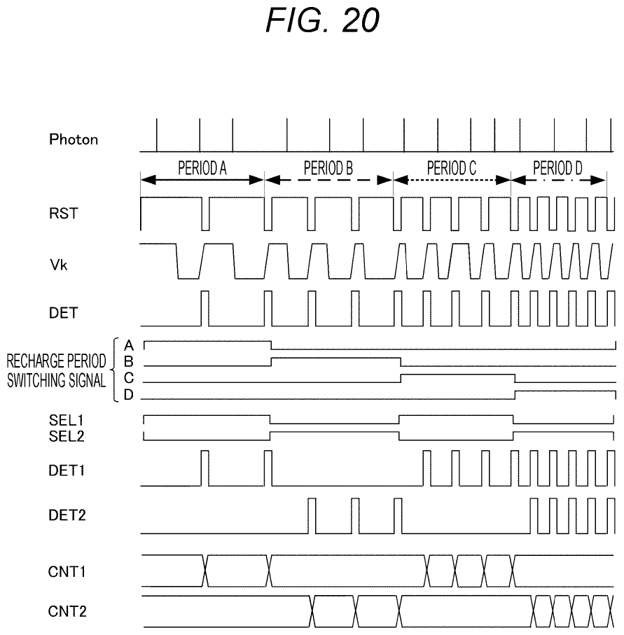

An example of a circuit operation of the pixel 2 according to the seventh embodiment of the above-described configuration will be described. FIG. 20 is a timing chart for explaining an example of the circuit operation of the pixel 2 of the imaging element 1 according to the seventh embodiment.

FIG. 20 illustrates a timing relationship among the reset pulse RST, the cathode voltage Vk of the SPAD element 10, the detection pulse DET, the recharge period switching signals A, B, C, D, the selection pulses SEL1 and SEL2, the first and second detection pulses DET1 and DET 2, and the first and second count values CNT1 and CNT2 with respect to incident photons.

As illustrated in the timing chart of FIG. 20, in the imaging element 1 according to the seventh embodiment, in the recharge control unit 32, four types of the recharge periods of the period A, period B, period C, and period D are set on the basis of four types of the recharge period switching signals A, B, C, and D as the periods of the reset pulse RST. Specifically, the period A is set in the high-level period of the switching signal A, the period B is set in the high-level period of the switching signal B, the period C is set in the high-level period of the switching signal C, and the period D is set in the high-level period of the switching signal D. Here, the relationship between the long and short periods of the reset pulse RST is, for example, the period A>the period B>the period C>the period D.

Furthermore, in the recharge control unit 32, the selection pulse SEL1 at the high level is generated in a period in which the recharge period switching signals A and C are at the high level, and the selection pulse SEL2 at the high level is generated in a period in which the recharge period switching signals B and D are at the high level. As a result, the logical switching of the selection pulses SEL1 and SEL2 is performed at the timing of switching the recharge period.

Then, the respective counters constituting the first storage unit 61 and the second storage unit 62 count the number of detected photons through repeating the switching between the first storage unit 61 and the second storage unit 62 under the control of the selection pulses SEL1 and SEL2. The count value CNT1 and count value CNT2 of the first storage unit 61 and second storage unit 62 are output as pixel signals corresponding to the number of detected photons in a predetermined exposure period.

As described above, in the imaging element 1 according to the seventh embodiment, the recharge control unit 32 that generates the reset pulse RST is configured to control to synchronize the switching of the period of the reset pulse RST with the operation of selecting the first storage unit 61 or the second storage unit 62 by generating the selection pulses SEL1 and SEL2 for switching between the plurality of storage units, on the basis of the recharge period switching signals A, B, C, and D. As a result, the switching timing of the recharge period and the switching timing of the first storage unit 61 with the second storage unit 62 can be aligned at the time of pulse generation in the recharge control unit 32.

### Eighth Embodiment

An eighth embodiment of the present technology is an example of generating selection pulses SEL1 and SEL2 for switching between a plurality of storage units outside a pixel array unit.

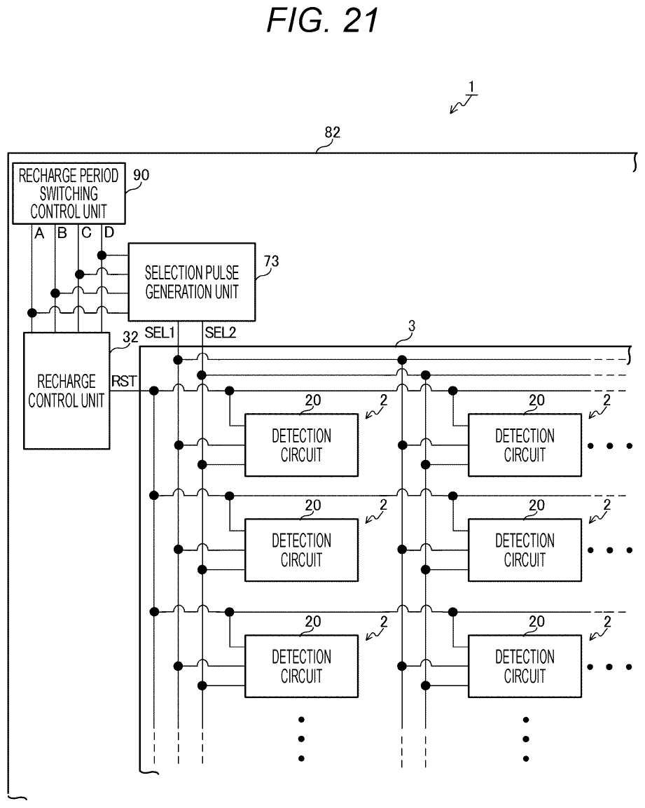

FIG. 21 is a block diagram illustrating a configuration example of an imaging element 1 according to the eighth embodiment of the present technology. In the stacked semiconductor chip structure illustrated in FIG. 1, detection circuits 20 that detect photons incident on SPAD elements 10 disposed in an array on a first semiconductor substrate 81 are disposed in an array per pixel 2 corresponding to the SPAD elements 10, on a second semiconductor substrate 82, to constitute a pixel array unit 3.

On the second semiconductor substrate 82, a recharge control unit 32 that generates a reset pulse RST, a selection pulse generation unit 73 that generates selection pulses SEL1 and SEL2, and a recharge period switching control unit 90 that generates recharge period switching signals A, B, C, and D are disposed outside the region of the pixel array unit 3. The reset pulse RST generated by the recharge control unit 32 and the selection pulses SEL1 and SEL2 generated by the selection pulse generation unit 73 are supplied to each detection circuit 20 in the pixel array unit 3.

The configuration of generating the reset pulse RST and the Selection pulses SEL1 and SEL2 on the basis of the recharge period switching signals A, B, C, and D exemplified herein corresponds to the configuration of the sixth embodiment illustrated in FIG. 17. The same applies to the ninth embodiment described later.

As described above, in the imaging element 1 according to the eighth embodiment, the selection pulse generation unit 73 is disposed outside the region of the pixel array unit 3, and the selection pulses SEL1 and SEL2 for switching between the plurality of storage units, that is, selecting the first storage unit 61 or the second storage unit 62 are generated outside the pixel array unit 3 and supplied to each of the detection circuits 20 of the pixel 2. Therefore, the circuit area of the region of the detection circuit 20 disposed per pixel on the second semiconductor substrate 82 can be reduced to be smaller than the case where the selection pulse generation unit 73 is disposed in the pixel 2.

### Ninth Embodiment

A ninth embodiment of the present technology is an example of generating selection pulses SEL1 and SEL2 for switching between a plurality of storage units inside a pixel array unit.

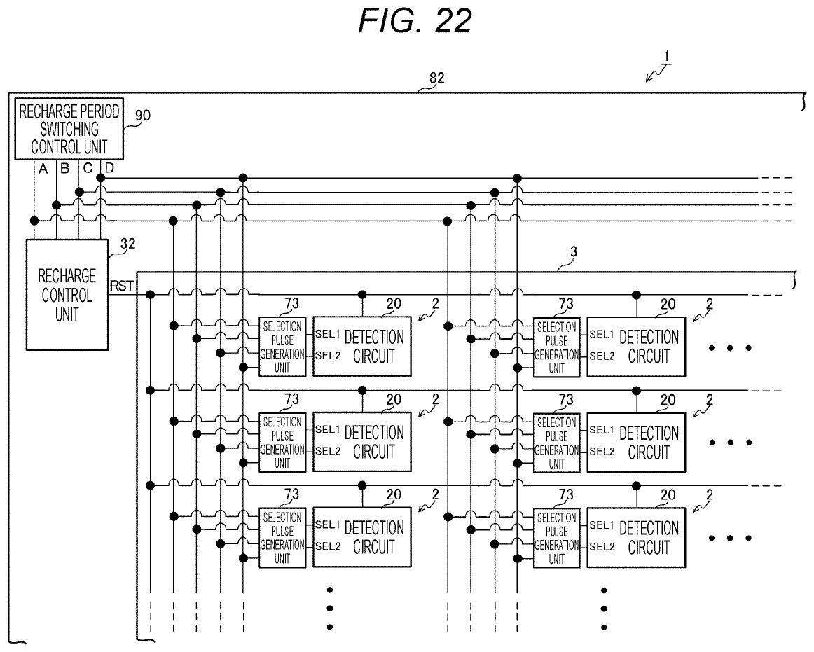

FIG. 22 is a block diagram illustrating a configuration example of an imaging element 1 according to the ninth embodiment of the present technology. In the stacked semiconductor chip structure illustrated in FIG. 1, detection circuits 20 that detect photons incident on SPAD elements 10 disposed in an array on a first semiconductor substrate 81 are disposed in an array per pixel 2 corresponding to the SPAD elements 10, on a second semiconductor substrate 82, to constitute a pixel array unit 3 together with the selection pulse generation unit 73.

On the second semiconductor substrate 82, a recharge control unit 32 that generates a reset pulse RST, and a recharge period switching control unit 90 that generates recharge period switching signals A, B, C, and D are disposed outside the region of the pixel array unit 3. The reset pulse RST generated by the recharge control unit 32 is supplied to each detection circuit 20 in the pixel array unit 3. The recharge period switching signals A, B, C, and D generated by the recharge period switching control unit 90 are supplied to each selection pulse generation unit 73 inside the pixel array unit 3.

As described above, in the imaging element 1 according to the ninth embodiment, the selection pulse generation unit 73 is disposed in the pixel array unit 3 per pixel 2, that is, to form a pair with the detection circuit 20, and the selection pulses SEL1 and SEL2 for selecting the first storage unit 61 or the second storage unit 62 are generated inside the pixel array unit 3 per pixel 2 and supplied to the detection circuit 20. Therefore, the circuit area of the region forming the circuit outside the pixel array unit 3 on the second semiconductor substrate 82 can be reduced to be smaller than the case where the selection pulse generation unit 73 is disposed outside the pixel array unit 3.

### Tenth Embodiment

A tenth embodiment of the present technology is an example of obtaining an image output on the basis of each output value of a plurality of storage units. The arithmetic processing of obtaining the image output can be performed in the imaging element 1 or can be performed by, for example, an application processor outside the imaging element 1. The same applies to the embodiments described later.

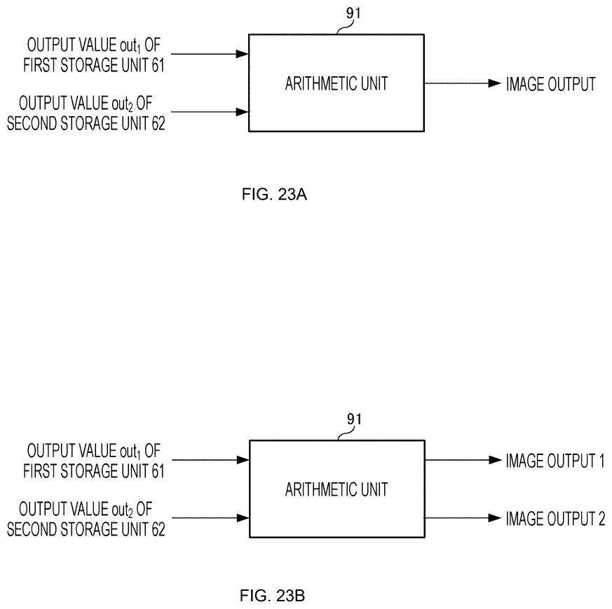

FIG. 23 is a block diagram illustrating a circuit configuration example of an arithmetic processing unit according to the tenth embodiment of the present technology. In the tenth embodiment, the arithmetic operation of the image output is performed on the basis of each output value of the plurality of storage units, for example, an output value out₁ of the first storage unit 61 and an output value out₂ of the second storage unit 62. The output values out₁ and out₂ of the first and second storage units 61 and 62 are hold values REG1 and REG2 in a case where the first and second storage units 61 and 62 are constructed by utilizing memories, and are count values CNT1 and CNT2 in a case where the first and second storage units 61 and 62 are constructed by utilizing counters.

### [Arithmetic Circuit Example 1]

a of FIG. 23 illustrates an example of a circuit configuration of an arithmetic processing unit according to an arithmetic circuit example 1. The arithmetic circuit example 1 includes, for example, an arithmetic unit 91 configured using a central processing unit (CPU). The arithmetic unit 91 calculates one image output on the basis of each output value of the plurality of storage units (in the present example, the output value out₁ of the first storage unit 61 and the output value out₂ of the second storage unit 62).

According to the example of the circuit configuration of the arithmetic circuit example 1, the image output calculated on the basis of each output value of the plurality of storage units can be used as it is as the imaging result.

### [Arithmetic Circuit Example 2]

b of FIG. 23 illustrates an example of a circuit configuration of an arithmetic processing unit according to an arithmetic circuit example 2. Similar to the arithmetic circuit example 1, the arithmetic circuit example 2 includes an arithmetic unit 91 configured utilizing, for example, a CPU. The arithmetic unit 91 calculates a plurality of image outputs (in the present example, two image outputs 1 and 2) on the basis of each output value of the plurality of storage units (in the present example, the output value out₁ of the first storage unit 61 and the output value out₂ of the second storage unit 62).

According to the example of the circuit configuration of the arithmetic circuit example 2, it is possible to acquire a plurality of images from a plurality of image outputs (in the present example, two image outputs 1 and 2) calculated on the basis of each output value of the plurality of storage units, or to acquire an image by optionally combining the images.

### Eleventh Embodiment

An eleventh Embodiment of the present technology is an example of obtaining the average illuminance in consideration of an illuminance change during an exposure period and estimating incident illuminance. Specifically, in the eleventh embodiment, an object for estimating the illuminance change is limited to two of the leading half illuminance and the trailing half illuminance (see FIG. 3) in one exposure period, and the incident illuminance that most matches the combination of the outputs of the plurality of storage units is then estimated.

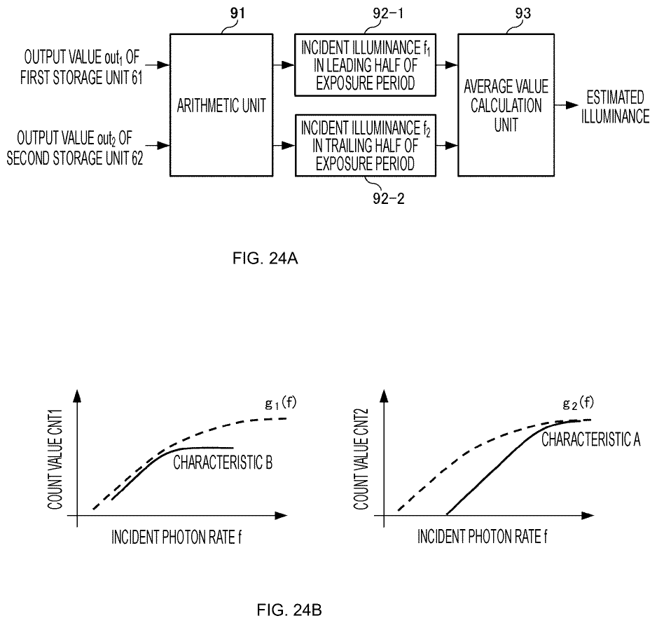

FIG. 24 is a diagram for explaining an arithmetic processing unit according to the eleventh embodiment of the present technology. a of FIG. 24 is a block diagram illustrating an example of a circuit configuration of the arithmetic processing unit, and b of FIG. 24 is a characteristic diagram illustrating a relationship between an incident photon rate f and count values CNT1 and CNT2. The count values CNT1 and CNT2 are output values out₁ and out₂ of first and second storage units 61 and 62 in a case where the count values CNT1 and CNT2 are constructed by utilizing counters.

In the characteristic diagram illustrated in b of FIG. 24, broken line curves g₁(f) and g₂(f) are known input/output characteristics obtained from the table created from the setting of the periods (recharge periods) of the recharge control.

As illustrated in a of FIG. 24, the arithmetic processing unit according to the eleventh embodiment includes, for example, an arithmetic unit 91 constructed by utilizing a CPU, a calculation unit 92-1 of an incident illuminance f₁ in the leading half of the exposure period, a calculation unit 92-2 of an incident illuminance f₂ in the trailing half of the exposure period, and an average value calculation unit 93.

Similar to the arithmetic circuit example 2 in the tenth embodiment, the arithmetic unit 91 calculates a plurality of image outputs (in the present example, two image outputs 1 and 2) on the basis of each output value of the plurality of storage units (in the present example, the output value out₁ of the first storage unit 61 and the output value out₂ of the second storage unit 62).

The incident illuminance calculation unit 92-1 in the leading half of the exposure period calculates the incident illuminance f₁ in the leading half of the exposure period based on the image output 1 output from the arithmetic unit 91, and the calculation unit 92-2 of the incident illuminance in the trailing half of the exposure period calculates the incident illuminance f₂ in the trailing half of the exposure period on the basis of the image output 2 output from the arithmetic unit 91.

The average value calculation unit 93 obtains an average value of the incident illuminance f₁ in the leading half of the exposure period calculated by the incident illuminance calculation unit 92-1 in the leading half of the exposure period and the incident illuminance f₂ in the trailing half of the exposure period calculated by the calculation unit 92-2 of the incident illuminance in the trailing half of the exposure period. The average value obtained by the average value calculation unit 93 is output as the estimated illuminance that most matches the combination of the output values (in the present example, the output value out₁ of the first storage unit 61 and the output value out₂ of the second storage unit 62) of the plurality of storage units.

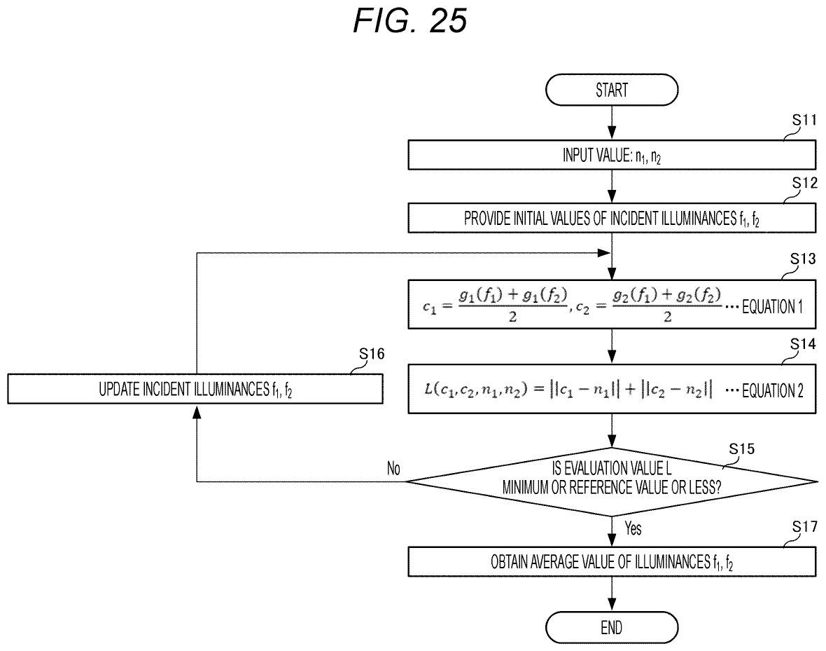

FIG. 25 is a flowchart illustrating a specific processing flow of the arithmetic processing unit according to the eleventh embodiment of the present technology.

First, the output value out₁ of the first storage unit 61 and the output value out₂ of the second storage unit 62 are set as input values (step S11), and initial values of the incident illuminance f₁ in the leading half of the exposure period and the incident illuminance f₂ in the trailing half of the exposure period are then provided (step S12).

Next, estimated values c₁ and c₂ of the output values out and out₂ of the first and second storage units 61 and 62 with respect to the incident illuminance f_{L} in the leading half of the exposure period and the incident illuminance f₂ in the trailing half of the exposure period are calculated (step S13). The arithmetic processing of calculating the estimated values c₁ and c₂ can be performed on the basis of the calculation equation of Equation 1 illustrated at step S13. Here, in a case where the recharge period is denoted by t, and the number of repetitions of repeating recharge during an exposure period is denoted by n, the known input/output characteristic g(f) with respect to the incident photon rate f is provided as follows:
g(f)=(1−e^{f·τ})·n.

Subsequently, an evaluation value L is calculated on the basis of the estimated values c₁ and c₂ and the actually obtained output values out₁ and out₂ of the first and second storage units 61 and 62 calculated at step S13 (step S14). The arithmetic processing of calculating the evaluation value L can be performed on the basis of the calculation equation of Equation 2 illustrated at step S14.

Next, it is determined whether the evaluation value L is the minimum or predetermined reference value or less (step S15), and provided that the evaluation value L is not the minimum or predetermined reference value or less (No at S15), the incident illuminances f₁ and f₂ are updated (step S16), and thereafter, the processing returns to step S13. Furthermore, in a case where the evaluation value L is the minimum or predetermined reference value or less (Yes at S15), that is, in a case where the evaluation value L is sufficiently small, it is determined that the estimated values c₁ and c₂ substantially match with the output values out₁ and out₂ of the first and second storage units 61 and 62, an average value thereof is obtained assuming that the values of the incident illuminances f₁ and f₂ are correct (step S17), and a series of arithmetic processing is terminated.

As described above, in the arithmetic processing unit according to the eleventh embodiment of the present technology, the processing of obtaining the estimated illuminance (estimated incident illuminance) of a period obtained by dividing one exposure period by the number of storage units is performed on the basis of each output value of the plurality of storage units (in the present example, the output value out₁ of the first storage unit 61 and the output value out₂ of the second storage unit 62). In this way, by obtaining the average illuminance in consideration of the illuminance change during the exposure period, it is possible to respond to the change in the illuminance of faster-moving objects.

### Twelfth Embodiment

A twelfth embodiment of the present technology is an example of obtaining estimated illuminance that most matches the combination of output values of a plurality of storage units using the inverse function table prepared in advance.

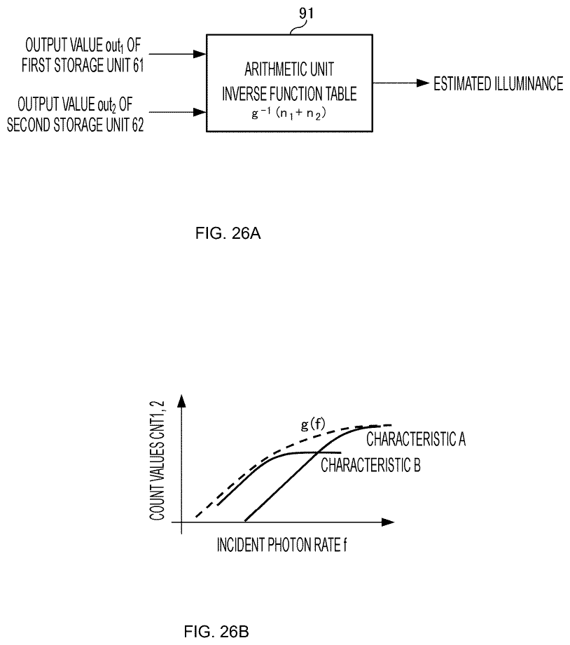

FIG. 26 is a diagram for explaining an arithmetic processing unit according to the twelfth embodiment of the present technology. a of FIG. 26 is a block diagram illustrating an example of a circuit configuration of the arithmetic processing unit, and b of FIG. 26 is a characteristic diagram illustrating a relationship between an incident photon rate f and count values CNT1 and CNT2. The count values CNT1 and CNT2 are output values out₁ and out₂ of first and second storage units 61 and 62 in a case where the count values CNT1 and CNT2 are constructed by utilizing counters.

In the twelfth embodiment, for example, the arithmetic unit 91 constructed by utilizing a CPU uses the output values out₁ and out₂ of the first and second storage units 61 and 62 as inputs, and has the inverse conversion table of g⁻¹(n₁−n₂) with respect to the inputs. In b of FIG. 26, g(f) is an input/output characteristic that can be calculated from the setting of the recharge period.

Here, in a case where the recharge periods are denoted by τ₁ and τ₂, the numbers of repetitions are denoted by n₁ and n₂, the input/output characteristic g(f) with respect to the incident photon rate f is provided as follows:

g(f)=(1−e^{f·τ1})·n₁+(1−e^{f·τ2})·n₂. As for g⁻¹, the inverse function of g is stored in advance as a table in the arithmetic unit 91.

As described above, in the arithmetic processing unit according to the twelfth embodiment of the present technology, the process of obtaining the estimated illuminance that most matches the combination of the output values of the plurality of storage units using the inverse function table prepared in advance, more specifically, the process of obtaining the average illuminance without considering the illuminance change during the exposure period is performed. By such simple processing, the image output proportional to the incident illuminance can be obtained for a still image.

### Modifications

Note that the embodiments described above illustrate examples for embodying the present technology, and the matters in the embodiments and the matters specifying the invention in the claims have correspondence relationships. Similarly, the matters specifying the invention in the claims and matters with the same names in the embodiments of the present technology have correspondence relationships. However, the present technology is not limited to the embodiments and may be embodied with various modifications of the embodiment without departing from the spirit thereof.

### Application Example to Electronic Apparatus

The imaging element according to the embodiments of the present technology described above is applicable to various electronic apparatuses having an imaging function, such as an imaging device such as a digital still camera or a video camera, a mobile terminal device having an imaging function such as a mobile phone, and a copier using an imaging device in an image reading unit.

### [Example of Imaging Device]

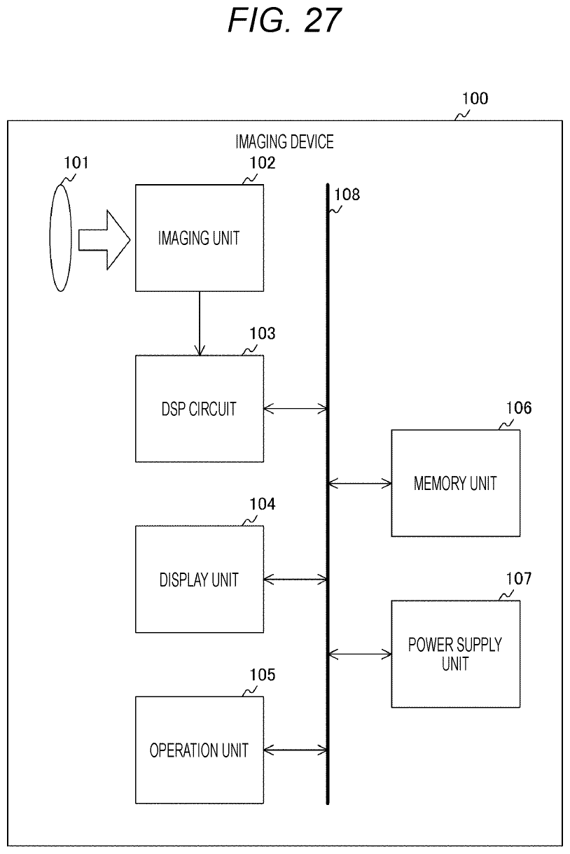

FIG. 27 is a block diagram illustrating a configuration example of an imaging device which is an example of an electronic apparatus to which the present technology is applied.

An imaging device 100 according to the present application example is a device for imaging a subject, and includes an imaging optical system 101 including a lens group and the like, an imaging unit 102, a digital signal processor (DSP) circuit 103, a display unit 104, an operation unit 105, a memory unit 106, and a power supply unit 107. These are connected to one another by a bus 108. As the imaging device 100, for example, in addition to a digital camera such as a digital still camera, a smartphone and a personal computer having an imaging function, an in-vehicle camera, and the like are assumed.

The imaging unit 102 generates pixel data by photoelectric conversion. As the imaging unit 102, the imaging element in the embodiments of the present technology can be used. Light from a subject is condensed and guided to a light receiving surface of the imaging unit 102 by the imaging optical system 101 disposed on an incident light side. The imaging unit 102 supplies pixel data generated by photoelectric conversion to the DSP circuit 103 in the subsequent stage.

The DSP circuit 103 executes predetermined signal processing on the pixel data from the imaging unit 102. The display unit 104 displays the pixel data. As the display unit 104, for example, a liquid crystal panel or an organic electro luminescence (EL) panel is assumed. The operation unit 105 generates an operation signal according to a user's operation. The memory unit 106 stores various types of data such as the pixel data. The power supply unit 107 supplies power to the imaging unit 102, the DSP circuit 103, the display unit 104, and the like.

In the imaging device 100 having the above-described configuration, since it is possible to substantially improve the frame rate by the number of storage units in the recharge control with a plurality of periods by using the imaging element according to the embodiments of the present technology as the imaging unit 102, and it is thus possible to obtain an imaged image with higher image quality.

### <Application Example of Embodiments of Present Technology>

The imaging element according to the above-described embodiments of the present technology can be applied to various technologies as exemplified below.

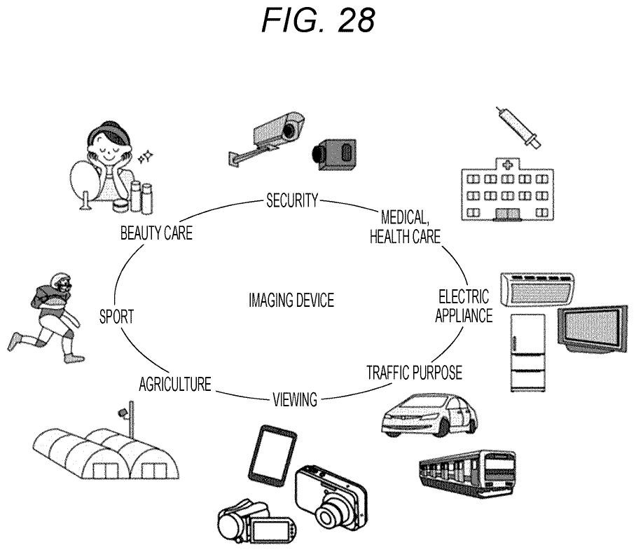

FIG. 28 illustrates an example of fields to which the imaging element according to the embodiments of the present technology is applied.

The imaging element according to the embodiments of the present technology can be, for example, used as a device that captures an image to be used for viewing, such as a digital camera or a portable device having a camera function.

Furthermore, this imaging element can be used as a device for traffic purpose such as an in-vehicle sensor which takes an image of surroundings, interior, or the like of an automobile, a surveillance camera for monitoring traveling vehicles and roads, and a ranging sensor which measures a distance between vehicles and the like for safe driving such as automatic stop, recognition of a driver's condition and the like.

Furthermore, this imaging element can be used as a device used for home electric appliances such as a television, a refrigerator, and an air conditioner in order to capture an image of a gesture of a user and perform device operation according to the gesture.

Furthermore, this imaging element can be used as a device for medical and health care use such as an endoscope and a device that performs angiography by receiving infrared light.

Furthermore, this imaging element can be used as a device for security use such as a security monitoring camera and an individual authentication camera.

Furthermore, this imaging element can be used as a device used for beauty care, such as a skin measuring instrument for imaging skin, and a microscope for imaging the scalp.

Furthermore, this imaging element can be used as a device used for sport, such as an action camera or a wearable camera for sports applications or the like.

Furthermore, this imaging element can be used as a device used for agriculture, such as a camera for monitoring a condition of a field or crop.

### Practical Example to Mobile Object

The technology according to the present disclosure (the present technology) can be applied to various products. For example, the technology according to the present disclosure may be realized as a device equipped on any type of mobile objects, such as an automobile, an electric car, a hybrid electric car, a motorcycle, a bicycle, personal mobility, an airplane, a drone, a ship, a robot, and the like.

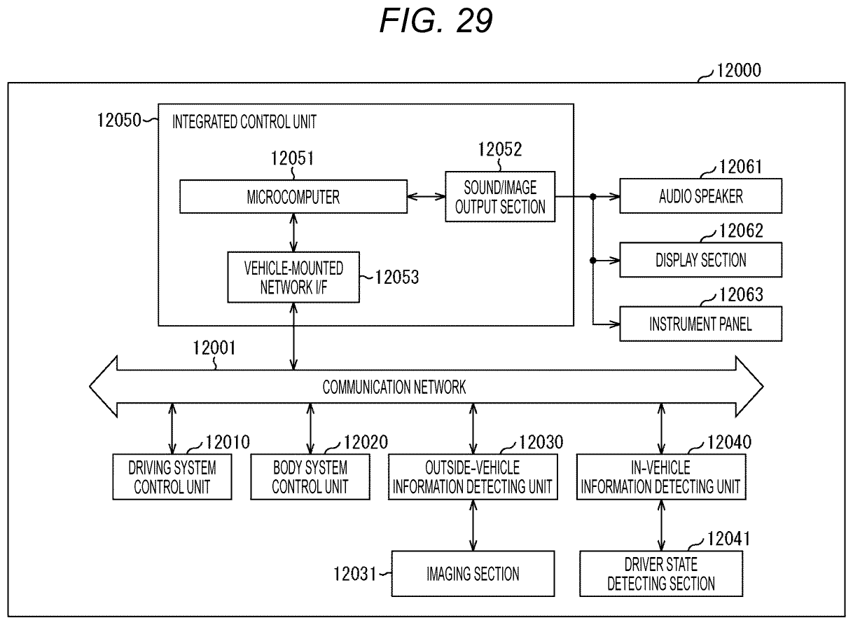

FIG. 29 is a block diagram illustrating a schematic configuration example of a vehicle control system as an example of a moving body control system to which the technology according to the present disclosure can be applied.

The vehicle control system 12000 includes a plurality of electronic control units connected to each other via a communication network 12001. In the example illustrated in FIG. 29, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 29, an audio speaker 12061, a display section 12062, and an instrument panel 12063 are illustrated as the output device. The display section 12062 may, for example, include at least one of an on-board display and a head-up display.

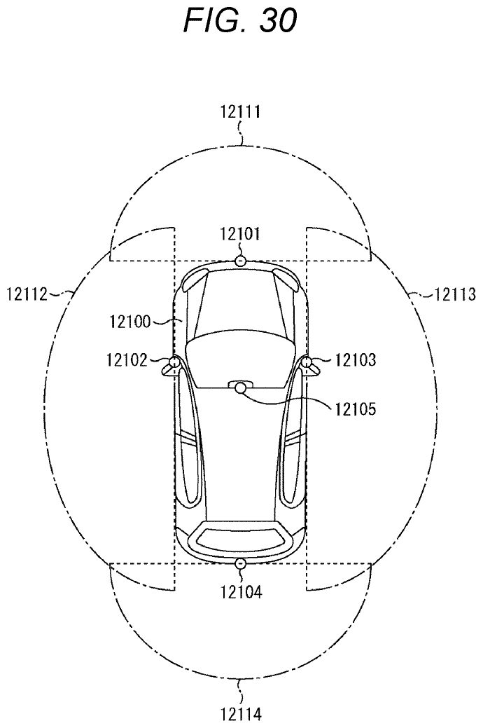

FIG. 30 is a diagram illustrating an example of the installation position of the imaging section 12031.

In FIG. 30, the imaging section 12031 includes imaging sections 12101, 12102, 12103, 12104, and 12105.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 30 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object.

When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to, for example, the imaging section 12031 among the configurations described above. Specifically, the imaging element 10 in FIG. 1 including the noise correction circuit in the embodiment of the technology according to the present disclosure can be applied to the imaging section 12031. By applying the technology according to the present disclosure to the imaging section 12031, it is possible to obtain an imaged image with higher image quality by substantially improving the frame rate by the number of storage units in the recharge control with a plurality of periods, and it is thus possible to reduce driver's fatigue.

### Configuration that Present Technology Can Employ

Note that the present technology may also have the following configurations.

(1) An imaging element including:
a light receiving element configured to detect a presence or absence of a photon, the light receiving element being provided for each pixel; and
a detection circuit configured to detect a photon incident on the light receiving element, the detection circuit being provided corresponding to the light receiving element, in which
the detection circuit includes
a photon detection unit configured to detect a photon incident on the light receiving element by recharge control with a plurality of periods with respect to the light receiving element,
a plurality of storage units, and
a selection control unit configured to select one of the plurality of storage units as a storage unit configured to store a number of detected photons detected by the photon detection unit.

(2) The imaging element according to (1), in which
the detection circuit further includes a counter configured to count a pulse generated when the photon detection unit detects a photon,
the plurality of storage units is constructed by utilizing memories, each storing a count value of the counter, and
the selection control unit is disposed between the counter and the plurality of storage units, and performs a control to selectively input the count value of the counter to the plurality of storage units.

(3) The imaging element according to (2), in which
the detection circuit further includes a read control unit configured to read, during a hold period of one storage unit of the plurality of storage units, a hold value of another storage unit.

(4) The imaging element according to (1), in which
the plurality of storage units are constructed by utilizing counters, each counting a pulse generated when the photon detection unit detects a photon, and
the selection control unit is disposed between the photon detection unit and the plurality of storage units, and performs a control to selectively input the number of detected photons to the plurality of storage units.

(5) The imaging element according to (4), in which
each counter of the plurality of storage units repeats a period in which a counting operation is performed and a period in which a counting operation is not performed a plurality of times.

(6) The imaging element according to any one of (1) to (5), in which
the selection control unit performs an operation of selecting one of the plurality of storage units in synchronization with switching of a period of the recharge control.

(7) The imaging element according to (6), in which
the selection control unit generates a selection pulse for selecting one of the plurality of storage units, and
the photon detection unit performs the recharge control with the plurality of periods in synchronization with the selection pulse.

(8) The imaging element according to (6), in which
the detection circuit further includes a recharge period switching control unit configured to switch the period of the recharge control, and
the selection control unit generates a selection pulse for selecting one of the plurality of storage units in synchronization with a switching signal output from the recharge period switching control unit.

(9) The imaging element according to (6), in which
the detection circuit further includes a recharge period switching control unit configured to switch the period of the recharge control, and
the photon detection unit generates a selection pulse for selecting one of the plurality of storage units on the basis of a switching signal output from the recharge period switching control unit.

(10) The imaging element according to any one of (1) to (9), in which
the imaging element has a stacked structure in which at least two semiconductor substrates are stacked, the at least two semiconductor substrates including
a first semiconductor substrate on which the light receiving element is formed and
a second semiconductor substrate on which the detection circuit is formed.

(11) The imaging element according to (10), in which
the imaging element further includes a selection pulse generation unit configured to generate a selection pulse for selecting one of the plurality of storage units, and the selection pulse generation unit is disposed on the second semiconductor substrate outside a pixel array unit in which the detection circuits are disposed in an array.

(12) The imaging element according to (10), in which
the imaging element further includes a selection pulse generation unit configured to generate a selection pulse for selecting one of the plurality of storage units, and the selection pulse generation unit is disposed on the second semiconductor substrate inside a pixel array unit in which the detection circuits are disposed in an array, and the selection pulse generation unit is disposed to form a pair with each detection circuit.

(13) The imaging element according to any one of (1) to (12), in which
the imaging element further includes an arithmetic processing unit configured to obtain an image output on the basis of each output value of the plurality of storage units.

(14) The imaging element according to (13), in which
the arithmetic processing unit obtains incident illuminance in a plurality of exposure periods from each output value of the plurality of storage units, and obtains average illuminance of the incident illuminance in the plurality of exposure periods.

(15) The imaging element according to any one of (1) to (14), in which
the light receiving element is an avalanche photodiode.

(16) The imaging element according to (15), in which
the light receiving element is a single photon avalanche diode.

(17) An electronic apparatus including an imaging element, in which
the imaging element includes:
a light receiving element configured to detect a presence or absence of a photon, the light receiving element being provided for each pixel; and
a detection circuit configured to detect a photon incident on the light receiving element, the detection circuit being provided corresponding to the light receiving element,
the detection circuit including
a photon detection unit configured to detect a photon incident on the light receiving element by recharge control with a plurality of periods with respect to the light receiving element,
a plurality of storage units, and
a selection control unit configured to select one of the plurality of storage units as a storage unit configured to store a number of detected photons detected by the photon detection unit.

### REFERENCE SIGNS LIST

1 Imaging element
2 Pixel
3 Pixel array unit
10 SPAD element (light receiving element)
20 Detection circuit
30 Photon detection unit
31 Recharge transistor
32 Recharge control unit
33 Waveform shaping unit
40 Counter
50 Hold pulse generation unit
60 Storage unit
61 First storage unit
62 Second storage unit
63 Read control unit
70 Selection control unit
71 First AND circuit
72 Second AND circuit
73 Selection pulse generation unit
81 First semiconductor substrate
82 Second semiconductor substrate
83 Wiring layer
84 Connecting part
90 Recharge period switching control unit
91 Arithmetic unit
92-1 Incident illuminance calculation unit in leading half of exposure period
92-2 Incident illuminance calculation unit in trailing half of exposure period
93 Average value calculation unit

1. An imaging element comprising:
a light receiving element configured to detect a presence or absence of a photon, the light receiving element being provided for each pixel; and
a detection circuit configured to detect a photon incident on the light receiving element, the detection circuit being provided corresponding to the light receiving element, wherein
the detection circuit includes
a photon detection unit configured to detect a photon incident on the light receiving element by recharge control with a plurality of periods with respect to the light receiving element,
a plurality of storage units, and
a selection control unit configured to select one of the plurality of storage units as a storage unit configured to store a number of detected photons detected by the photon detection unit.

2. The imaging element according to claim 1, wherein
the detection circuit further includes a counter configured to count a pulse generated when the photon detection unit detects a photon,
the plurality of storage units is constructed by utilizing memories, each storing a count value of the counter, and
the selection control unit is disposed between the counter and the plurality of storage units, and performs a control to selectively input the count value of the counter to the plurality of storage units.

3. The imaging element according to claim 2, wherein
the detection circuit further includes a read control unit configured to read, during a hold period of one storage unit of the plurality of storage units, a hold value of another storage unit.

4. The imaging element according to claim 1, wherein
the plurality of storage units are constructed by utilizing counters, each counting a pulse generated when the photon detection unit detects a photon, and
the selection control unit is disposed between the photon detection unit and the plurality of storage units, and performs a control to selectively input the number of detected photons to the plurality of storage units.

5. The imaging element according to claim 4, wherein
each counter of the plurality of storage units repeats a period in which a counting operation is performed and a period in which a counting operation is not performed a plurality of times.

6. The imaging element according to claim 1, wherein
the selection control unit performs an operation of selecting one of the plurality of storage units in synchronization with switching of a period of the recharge control.

7. The imaging element according to claim 6, wherein
the selection control unit generates a selection pulse for selecting one of the plurality of storage units, and
the photon detection unit performs the recharge control with the plurality of periods in synchronization with the selection pulse.

8. The imaging element according to claim 6, wherein
the detection circuit further includes a recharge period switching control unit configured to switch the period of the recharge control, and
the selection control unit generates a selection pulse for selecting one of the plurality of storage units in synchronization with a switching signal output from the recharge period switching control unit.

9. The imaging element according to claim 6, wherein
the detection circuit further includes a recharge period switching control unit configured to switch the period of the recharge control, and
the photon detection unit generates a selection pulse for selecting one of the plurality of storage units on a basis of a switching signal output from the recharge period switching control unit.

10. The imaging element according to claim 1, wherein
the imaging element has a stacked structure in which at least two semiconductor substrates are stacked, the at least two semiconductor substrates including
a first semiconductor substrate on which the light receiving element is formed and
a second semiconductor substrate on which the detection circuit is formed.

11. The imaging element according to claim 10, wherein
the imaging element further comprises a selection pulse generation unit configured to generate a selection pulse for selecting one of the plurality of storage units, and
the selection pulse generation unit is disposed on the second semiconductor substrate outside a pixel array unit in which the detection circuits are disposed in an array.

12. The imaging element according to claim 10, wherein
the imaging element further comprises a selection pulse generation unit configured to generate a selection pulse for selecting one of the plurality of storage units, and
the selection pulse generation unit is disposed on the second semiconductor substrate inside a pixel array unit in which the detection circuits are disposed in an array, and the selection pulse generation unit is disposed to form a pair with each detection circuit.

13. The imaging element according to claim 1, wherein
the imaging element further comprises an arithmetic processing unit configured to obtain an image output on a basis of each output value of the plurality of storage units.

14. The imaging element according to claim 13, wherein
the arithmetic processing unit obtains incident illuminance in a plurality of exposure periods from each output value of the plurality of storage units, and obtains average illuminance of the incident illuminance in the plurality of exposure periods.

15. The imaging element according to claim 1, wherein
the light receiving element is an avalanche photodiode.

16. The imaging element according to claim 15, wherein
the light receiving element is a single photon avalanche diode.

17. An electronic apparatus comprising an imaging element, wherein
the imaging element includes:
a light receiving element configured to detect a presence or absence of a photon, the light receiving element being provided for each pixel; and
a detection circuit configured to detect a photon incident on the light receiving element, the detection circuit being provided corresponding to the light receiving element,
the detection circuit including
a photon detection unit configured to detect a photon incident on the light receiving element by recharge control with a plurality of periods with respect to the light receiving element,
a plurality of storage units, and
a selection control unit configured to select one of the plurality of storage units as a storage unit configured to store a number of detected photons detected by the photon detection unit.
